(19) United States
(12) Patent Application Publication
(10) Pub. No.: US 2025/0067164 A1
(43) Pub. Date: Feb. 27, 2025

(54) FIELD PUMP EQUIPMENT SYSTEM

(71) Applicant: SCHLUMBERGER TECHNOLOGY CORPORATION, Sugar Land, TX (US)

(72) Inventors: Supriya GUPTA, Houston, TX (US); Lichi DENG, Spring, TX (US); Amey AMBADE, Houston, TX (US); Miguel Angel HERNANDEZ DE LA BASTIDA, Sugar Land, TX (US)

(21) Appl. No.: 18/720,762

(22) PCT Filed: Jun. 9, 2022
(86) PCT No.: PCT/US2022/032836

§ 371 Date: Jun. 17, 2024

Related U.S. Application Data
(60) Provisional application No. 63/300,121, filed on Jan. 17, 2022.

(51) Int. Cl. E21B 47/008; E21B 44/00

(52) U.S. Cl. CPC E21B 47/008; E21B 44/00; E21B 2200/20

(57) ABSTRACT

A method can include, receiving by a computational device at a wellsite, real-time, time series data from pump equipment at the wellsite, where the wellsite includes a wellbore in contact with a fluid reservoir; using the computational device, processing the time series data as input to a trained machine learning model to detect a performance issue of the pump equipment; and issuing a signal responsive to detection of the performance issue.

### RELATED APPLICATIONS

This application claims priority to and the benefit of a US Provisional Application having Ser. No. 63/300,121, filed Jan. 17, 2022, which is incorporated by reference herein.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.). Various operations may be performed in the field to access such hydrocarbon fluids and/or produce such hydrocarbon fluids. For example, consider equipment operations where equipment may be controlled to perform one or more operations.

### SUMMARY

A method can include, receiving by a computational device at a wellsite, real-time, time series data from pump equipment at the wellsite, where the wellsite includes a wellbore in contact with a fluid reservoir; using the computational device, processing the time series data as input to a trained machine learning model to detect a performance issue of the pump equipment; and issuing a signal responsive to detection of the performance issue. A wellsite system can include a processor; memory accessible to the processor; and processor-executable instructions stored in the memory to instruct the system to: receive real-time, time series data from pump equipment at the wellsite, where the wellsite includes a wellbore in contact with a fluid reservoir; process the time series data as input to a trained machine learning model to detect a performance issue of the pump equipment; and issue a signal responsive to detection of the performance issue. One or more computer-readable storage media can include processor-executable instructions to instruct a wellsite computing system to: receive real-time, time series data from pump equipment at the wellsite, where the wellsite includes a wellbore in contact with a fluid reservoir; process the time series data as input to a trained machine learning model to detect a performance issue of the pump equipment; and issue a signal responsive to detection of the performance issue. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates examples of equipment, an example of a network and an example of a system;

FIG. 3 illustrates example of equipment;

FIG. 4 illustrates an example of an electric submersible pump system;

FIG. 5 illustrates an example of a system;

FIG. 6 illustrates an example of a system;

FIG. 7 illustrates an example of a system;

FIG. 8 illustrates an example of a method;

FIG. 9 illustrates an example of a system and an example of a plot;

FIG. 10 illustrates examples of plots;

FIG. 11 illustrates an example of a method;

FIG. 12 illustrates an example of a method;

FIG. 13 illustrates an example of a method;

FIG. 14 illustrates an example of a system;

FIG. 15 illustrates an example of a plot of time series data;

FIG. 16 illustrates examples of plots of time series data;

FIG. 17 illustrates an example of a system;

FIG. 18 illustrates an example of a system;

FIG. 19 illustrates an example of a system;

FIG. 20 illustrates an example of a method and an example of a system;

FIG. 21 illustrates examples of computer and network equipment; and

FIG. 22 illustrates example components of a system and a networked system.

### DETAILED DESCRIPTION

This description is not to be taken in a limiting sense, but rather is made merely for the purpose of describing the general principles of the implementations. The scope of the described implementations should be ascertained with reference to the issued claims.

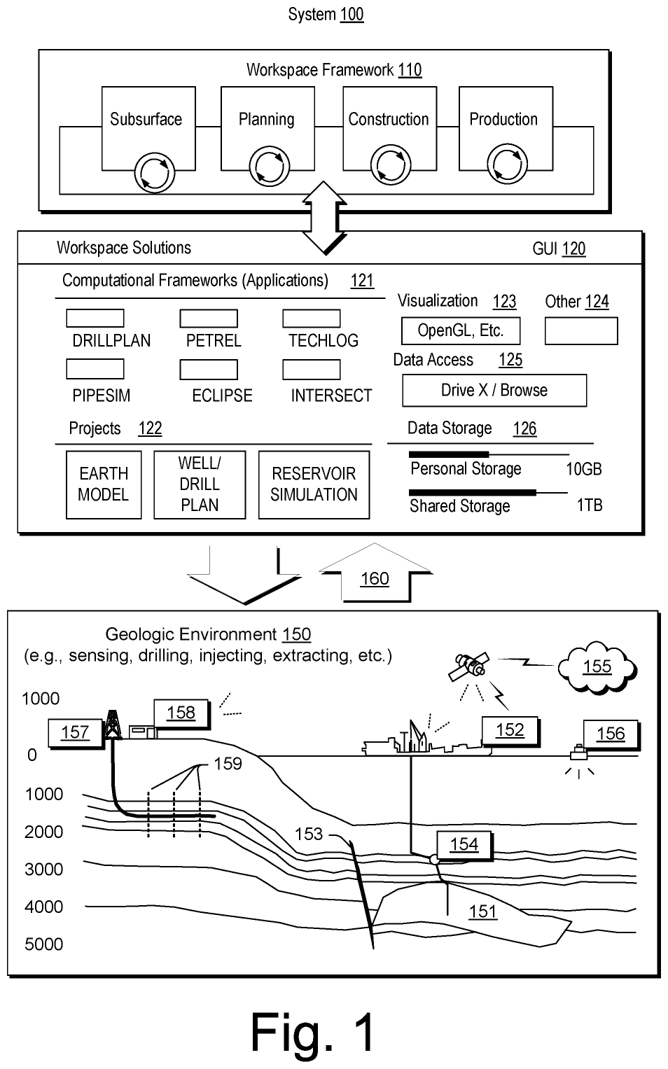

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (Schlumberger Limited, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (Schlumberger Limited, Houston, Texas, referred to as the DELFI environment) for utilization in geosciences and geoengineering, for example, to analyze subsurface data from exploration to production of fluid from a reservoir.

One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). As an example, such an environment can provide for operations that involve one or more frameworks. The DELFI environment may be referred to as the DELFI framework, which may be a framework of frameworks. As an example, the DELFI environment can include various other frameworks, which can include, for example, one or more types of models (e.g., simulation models, etc.).

The TECHLOG framework can handle and process field and laboratory data for a variety of geologic environments (e.g., deepwater exploration, shale, etc.). The TECHLOG framework can structure wellbore data for analyses, planning, etc.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (Schlumberger Limited, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G software packages.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. In such an approach, one or more features of a framework that may be available in one language may be accessed via a converter. For example, consider the APACHE SPARK framework that can include features available in a particular language where a converter may convert code in another language to that particular language such that one or more of the features can be utilized. As an example, a production field may include various types of equipment, be operable with various frameworks, etc., where one or more languages may be utilized. In such an example, a converter may provide for feature flexibility and/or compatibility.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

While several simulators are illustrated in the example of FIG. 1, one or more other simulators may be utilized, additionally or alternatively. For example, consider the VISAGE geomechanics simulator (Schlumberger Limited, Houston Texas) or the PETROMOD simulator (Schlumberger Limited, Houston Texas), etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc. The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions. The MANGROVE simulator (Schlumberger Limited, Houston, Texas) provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

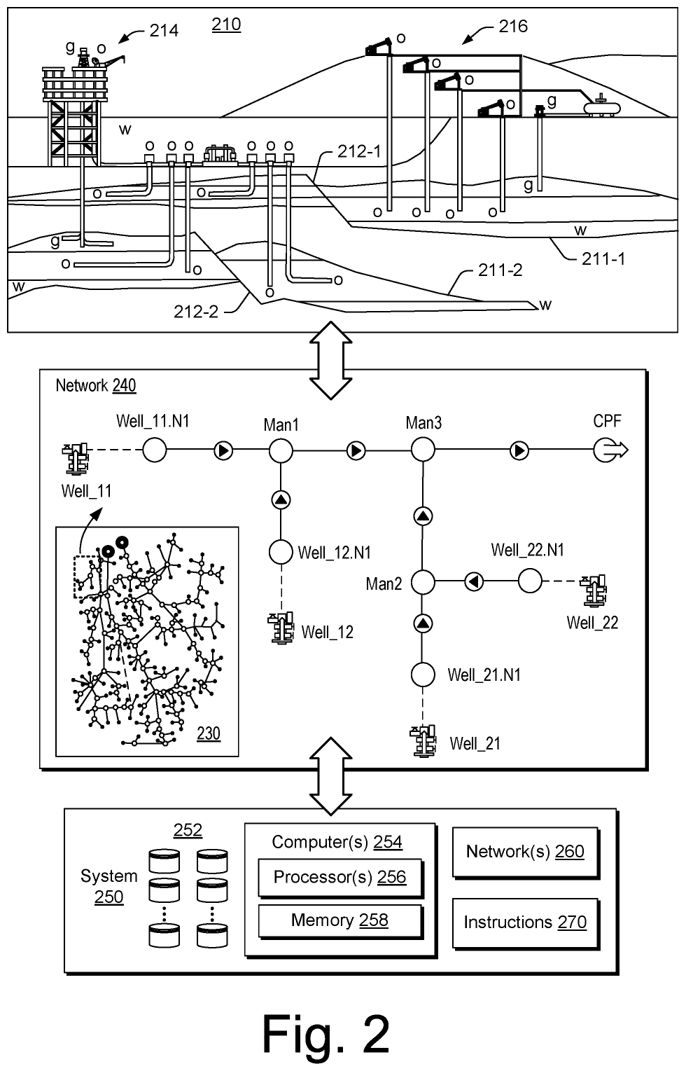

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1. In the example of FIG. 2, the geologic environment 210 can include fluids such as oil (o), water (w) and gas (g), which may be stratified in the reservoirs 211-1 and 211-2.

In the example of FIG. 2, the equipment 214 and 216 can include one or more of drilling equipment, wireline equipment, production equipment, etc. For example, consider the equipment 214 as including a drilling rig that can drill into a formation to reach a reservoir target where a well can be completed for production of hydrocarbons. As an example, the equipment 216 can include production equipment such as wellheads, valves, pump equipment, gas handling equipment, etc. As an example, one or more features of the system 100 of FIG. 1 may be utilized for operations in the geologic environment 210. For example, consider utilizing a drilling or well plan framework, a drilling execution framework, a production framework, etc., to plan, execute, etc., one or more drilling operations, production operations, etc.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of fluid (e.g., oil, water and/or gas) from well locations along flowlines interconnected at junctions with final delivery at a central processing facility (CPF). Where fluid includes solids (e.g., sand, etc.), one or more pieces of equipment may provide for solids removal, collection, etc.

In the example of FIG. 2, various portions of the network 240 may include conduit. For example, consider a perspective view of a geologic environment that includes two conduits which may be a conduit to Man1 and a conduit to Man3 in the network 240, where Man1, Man2 and Man3 are manifolds.

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.) and/or other modeling. As an example, one or more methods, techniques, etc. may be performed using one or more sets of instructions, which may be, for example, the instructions 270 of FIG. 2.

As an example, various graphics in FIG. 2 may be part of a graphical user interface (GUI) that can be generated using executable instructions that may be executable locally and/or remotely using local and/or remote display devices (e.g., a mobile device, a workstation, etc.).

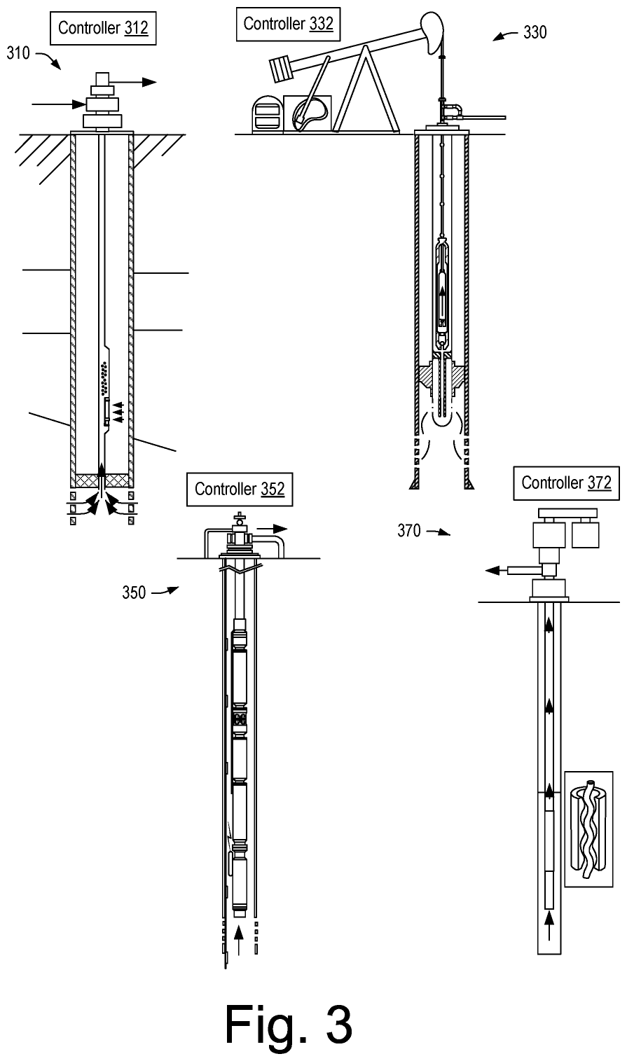

FIG. 3 shows examples of equipment 310, 330, 350 and 370 that can be utilized in the field to move fluid. As shown, the equipment 310 can include gas-lift equipment, the equipment 330 can include sucker rod pump equipment, the equipment 350 can include electric submersible pump (ESP) equipment, and the equipment 370 can include progressive cavity pump (PCP) equipment.

In FIG. 3, the equipment 310, 330, 350 and 370 can be artificial lift equipment, where one or more controllers 312, 332, 352 and 372 can be included with the equipment 310, 330, 350 and 370 and/or operatively coupled to the equipment 310, 330, 350 and 370. In such an example, one or more features of the system 250 may be included in the one or more controllers 312, 332, 352 and 372 and/or operatively coupled to the one or more controllers 312, 332, 352 and 372.

Artificial lift equipment can add energy to a fluid column in a wellbore with the objective of initiating and/or improving production from a well. Artificial lift systems can utilize a range of operating principles (e.g., rod pumping, gas lift, electric submersible pumps, etc.). As such, artificial lift equipment can operate through utilization of one or more resources (e.g., fuel, electricity, gas, etc.).

Gas lift is an artificial-lift method in which gas is injected into production tubing to reduce hydrostatic pressure of a fluid column. The resulting reduction in bottomhole pressure allows reservoir liquids to enter a wellbore at a higher flow rate. In gas lift, injection gas can be conveyed down a tubing-casing annulus and enter a production train through a series of gas-lift valves. In such an approach, a gas-lift valve position, operating pressure and gas injection rate may be operational parameters (e.g., determined by specific well conditions, etc.).

A sucker rod pump is an artificial-lift pumping system that uses a surface power source to drive a downhole pump assembly. For example, a beam and crank assembly can create reciprocating motion in a sucker rod string that connects to a downhole pump assembly. In such an example, the pump can include a plunger and valve assembly to convert the reciprocating motion to vertical fluid movement. As an example, a sucker rod pump may be driven using electricity and/or fuel. For example, a prime mover of a sucker rod pump can be an electric motor or an internal combustion engine.

An ESP is an artificial-lift system that utilizes a downhole pumping system that is electrically driven. In such an example, the pump can include staged centrifugal pump sections that can be specifically configured to suit production and wellbore characteristics of a given application. ESP systems may provide flexibility over a range of sizes and output flow capacities.

A PCP is a type of a sucker rod-pumping unit that uses a rotor and a stator. In such an approach, rotation of a rod by means of an electric motor at surface causes fluid contained in a cavity to flow upward. A PCP may be referred to as a rotary positive-displacement unit.

In the examples of FIG. 3, one or more sensors may be included. For example, consider a gauge coupled to a downhole end of an ESP where signals from sensors of the gauge can be transmitted to surface equipment using a power cable and/or a dedicated gauge cable. For example, consider the PHOENIX gauge (Schlumberger Limited, Houston, Texas), which include sensors that can measure intake pressure, temperature, motor oil temperature, winding temperature, vibration, current leakage and/or pump discharge pressure. A gauge may be operatively coupled to a controller, which may, for example, provide controls for backspin of an ESP, sanding of an ESP, flux of an ESP and gas related issues of an ESP. For example, during operation where sand is present (e.g., suspended solid matter, etc.), sand may accumulate in one or more stages of an ESP where a control scheme may act to rid the ESP of at least a portion of the sand.

As an example, a PCP may be suitable for use in production for wells characterized by highly viscous fluid and high sand cut where the PCP has some sand-lifting capability. However, sand may accumulate where a control scheme may be utilized to rid the PCP of at least a portion of the sand.

As an example, a sucker rod pump may be operable as a stroke-through pump to release sand and other material. In such an example, to minimize damage to a plunger and barrel, a grooved-body plunger may be used to catch and carry the sand away from those components.

As an example, gas lift equipment may be utilized in applications where abrasive materials, such as sand, may be present and can be used in low-productivity, high-gas/oil ratio-wells or deviated wellbores. As an example, gas lift equipment such as pocketed mandrels can utilize slickline-retrievable gas lift valves, which may be pulled and replaced without disturbing tubing.

As an example, equipment may include water flooding equipment. For example, consider an enhanced oil recovery (EOR) process in which a small amount of surfactant is added to an aqueous fluid injected to sweep a reservoir. In such an example, presence of surfactant reduces the interfacial tension between oil and water phases and may also alter wettability of reservoir rock (e.g., to improve oil recovery). In such an example, movement of fluid (e.g., oil and/or water) and/or presence of surfactant may carry particles of the reservoir rock to a production well or production wells where such particles (e.g., sand) can result in a sand event, whether one or more of the production well or wells include artificial lift equipment or not. As water flooding becomes more prevalent globally, an increase in sand related issues may be expected (e.g., sand influx into production wells).

As an example, equipment can include a choke or chokes, which can include a surface choke and/or a downhole choke. A choke is a device that includes an orifice that can be used to control flow of fluid through the orifice, for example, to control fluid flow rate, downstream system pressure, etc. Chokes are available in various configurations, which include fixed and adjustable chokes. An adjustable choke enables fluid flow and pressure parameters to be changed as desired (e.g., for process, production, etc.).

An adjustable choke includes a valve that can be adjusted to control well operations, for example, to reduce pressure of a fluid from high pressure in a closed wellbore to atmospheric pressure. An adjustable choke valve may be adjusted (e.g., fully opened, partially opened or closed) to control pressure drop. As an example, an adjustable choke may be manually adjustable or adjustable via a controller that may be integral to or operatively coupled to the adjustable choke. A controller for an adjustable choke may respond to locally generated and/or remotely generated signals.

A downhole choke or bottom hole choke can be a downhole device used to control fluid flow under downhole conditions. As an example, a downhole choke may be removable via slickline intervention where the downhole choke may be located in a landing nipple in a tubing string. In some scenarios, a downhole chock may be used as a flow regulator and to take part of the pressure drop downhole, which may help to reduce potential of hydrate issues.

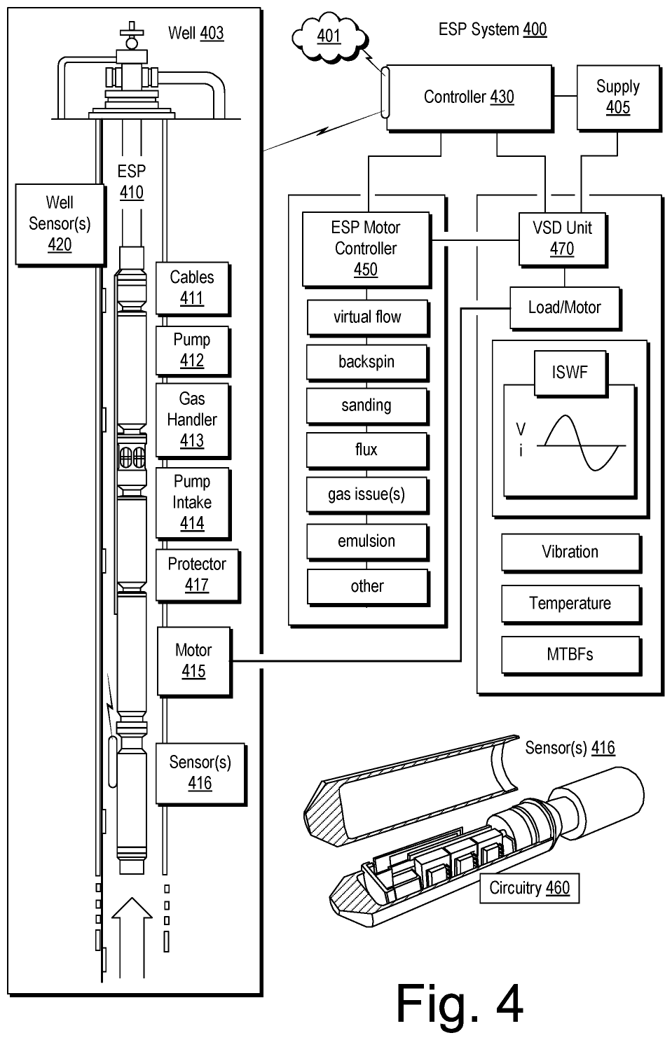

FIG. 4 shows an example of an ESP system 400 that includes an ESP 410 as an example of equipment that may be placed in a geologic environment. As an example, an ESP may be expected to function in an environment over an extended period of time (e.g., optionally of the order of years).

In the example of FIG. 4, the ESP system 400 includes a network 401, a well 403 disposed in a geologic environment (e.g., with surface equipment, etc.), a power supply 405, the ESP 410, a controller 430, a motor controller 450 and a variable speed drive (VSD) unit 470. The power supply 405 may receive power from a power grid, an onsite generator (e.g., natural gas driven turbine), or other source. The power supply 405 may supply a voltage, for example, of about 4.16 kV.

As shown, the well 403 includes a wellhead that can include a choke (e.g., a choke valve). For example, the well 403 can include a choke valve to control various operations such as to reduce pressure of a fluid from high pressure in a closed wellbore to atmospheric pressure. A wellhead may include one or more sensors such as a temperature sensor, a pressure sensor, a solids sensor, etc. As an example, a wellhead can include a temperature sensor and a pressure sensor.

As to the ESP 410, it is shown as including cables 411 (e.g., or a cable), a pump 412, gas handling features 413, a pump intake 414, a motor 415, one or more sensors 416 (e.g., temperature, pressure, strain, current leakage, vibration, etc.) and a protector 417.

As an example, an ESP may include a REDA HOTLINE high-temperature ESP motor. As an example, an ESP motor can include a three-phase squirrel cage with two-pole induction. As an example, an ESP motor may include steel stator laminations that can help focus magnetic forces on rotors, for example, to help reduce energy loss. As an example, stator windings can include copper and insulation.

As an example, the one or more sensors 416 of the ESP 410 may be part of a digital downhole monitoring system. For example, consider the PHOENIX MULTISENSOR XT150 system (Schlumberger Limited, Houston, Texas). A monitoring system may include a base unit that operatively couples to an ESP motor (see, e.g., the motor 415), for example, directly, via a motor-base crossover, etc. As an example, such a base unit (e.g., base gauge) may measure intake pressure, intake temperature, motor oil temperature, motor winding temperature, vibration, currently leakage, etc. As an example, a base unit may transmit information via a power cable that provides power to an ESP motor and may receive power via such a cable as well.

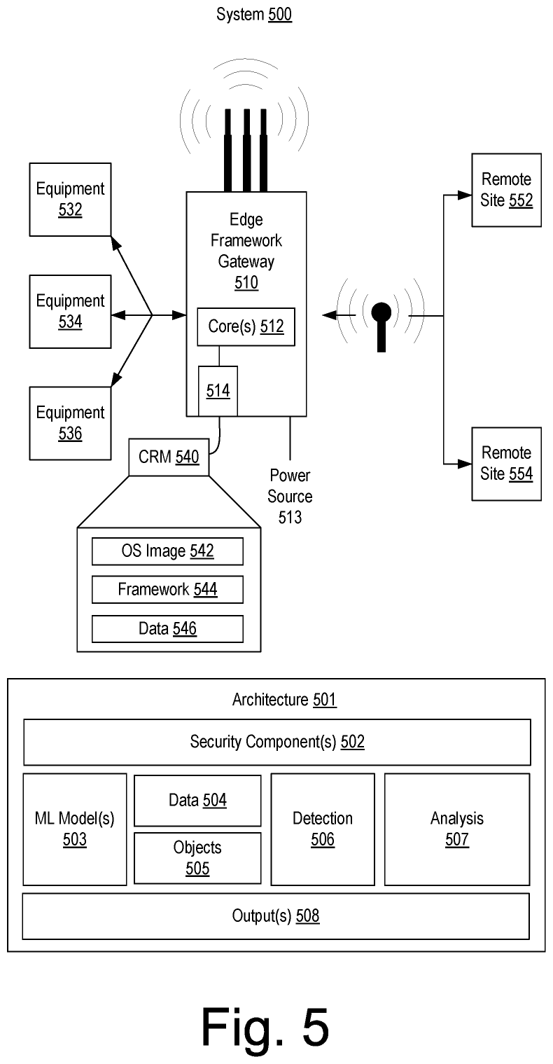

As shown in the example of FIG. 4, the one or more sensors 416 can include circuitry 460. As an example, such circuitry 460 can include one or more processors and memory that can store processor-executable instructions. As an example, such instructions can include instructions for one or more monitoring and/or control features. As an example, the circuitry 460 may be utilized as an edge device and/or as part of an edge device (see, e.g., FIG. 5).

As an example, a remote unit may be provided that may be located at a pump discharge (e.g., located at an end opposite the pump intake 414). As an example, a base unit and a remote unit may, in combination, measure intake and discharge pressures across a pump (see, e.g., the pump 412), for example, for analysis of a pump curve. As an example, alarms may be set for one or more parameters (e.g., measurements, parameters based on measurements, etc.).

Where a system includes a base unit and a remote unit, such as those of the PHOENIX™ MULTISENSOR XT150 system, the units may be linked via wires. Such an arrangement provide power from the base unit to the remote unit and allows for communication between the base unit and the remote unit (e.g., at least transmission of information from the remote unit to the base unit). As an example, a remote unit is powered via a wired interface to a base unit such that one or more sensors of the remote unit can sense physical phenomena. In such an example, the remote unit can then transmit sensed information to the base unit, which, in turn, may transmit such information to a surface unit via a power cable configured to provide power to an ESP motor.

In the example of FIG. 4, the well 403 may include one or more well sensors 420, for example, such as the OPTICLINE™ sensors or WELLWATCHER BRITEBLUE™ sensors (Schlumberger Limited, Houston, Texas). Such sensors are fiber-optic based and can provide for real time sensing of temperature, for example, in SAGD or other operations. As shown in the example of FIG. 1, a well can include a relatively horizontal portion. Such a portion may collect heated heavy oil responsive to steam injection. Measurements of temperature along the length of the well can provide for feedback, for example, to understand conditions downhole of an ESP. Well sensors may extend a considerable distance into a well and possibly beyond a position of an ESP.

In the example of FIG. 4, the controller 430 can include one or more interfaces, for example, for receipt, transmission or receipt and transmission of information with the motor controller 450, a VSD unit 470, the power supply 405 (e.g., a gas fueled turbine generator, a power company, etc.), the network 401, equipment in the well 403, equipment in another well, etc.

As an example, the controller 430 may include features of an ESP motor controller and optionally supplant the ESP motor controller 450. For example, the controller 430 may include features of the INSTRUCT motor controller (Schlumberger Limited, Houston, Texas) and/or features of the UNICONN motor controller (Schlumberger Limited, Houston, Texas), which may connect to a SCADA system, the ESPWATCHER surveillance system (Schlumberger Limited, Houston, Texas), the LIFTWATCHER system (Schlumberger Limited, Houston, Texas), LIFTIQ system (Schlumberger Limited, Houston, Texas), etc. The UNICONN motor controller and/or the INSTRUCT motor controller can perform some control and data acquisition tasks for ESPs, surface pumps or other monitored wells. As an example, a motor controller can interface with the aforementioned PHOENIX™ monitoring system, for example, to access pressure, temperature and vibration data and various protection parameters as well as to provide direct current power to downhole sensors. As an example, a motor controller can interface with fixed speed drive (FSD) controllers or a VSD unit, for example, such as the VSD unit 470.

For FSD controllers, a motor controller can monitor ESP system three-phase currents, three-phase surface voltage, supply voltage and frequency, ESP spinning frequency and leg ground, power factor and motor load. For VSD units, a motor controller can monitor VSD output current, ESP running current, VSD output voltage, supply voltage, VSD input and VSD output power, VSD output frequency, drive loading, motor load, three-phase ESP running current, three-phase VSD input or output voltage, ESP spinning frequency, and leg-ground.

In the example of FIG. 4, the ESP motor controller 450 includes various modules to handle, for example, virtual flow estimations, backspin of an ESP, sanding of an ESP, flux of an ESP, gas issues of an ESP, emulsion presence, emulsion formation, etc. The motor controller 450 may include any of a variety of features, additionally, alternatively, etc.

In the example of FIG. 4, the VSD unit 470 may be a low voltage drive (LVD) unit, a medium voltage drive (MVD) unit or other type of unit (e.g., a high voltage drive, which may provide a voltage in excess of about 4.16 kV). As an example, the VSD unit 470 may receive power with a voltage of about 4.16 kV and control a motor as a load with a voltage from about 0 V to about 4.16 kV. The VSD unit 470 may include control circuitry such as the SPEEDSTAR MVD control circuitry (Schlumberger Limited, Houston, Texas).

FIG. 5 shows an example of a system 500 and an example of an architecture 501 where the system 500 can include various local components that can be in communication with one or more remote components. As shown in the example of FIG. 5, the architecture 501 can provide for one or more security components 502, one or more machine learning models 503, data 504, objects 505, detection techniques 506 (e.g., recognition, detection, prediction, etc.), analysis techniques 507 and output(s) 508. As an example, the system 500 may be operatively coupled to one or more pumps, which can include one or more ESPs. As an example, the system 500 may operate as a controller, a motor controller, etc., and/or provide information to a controller, a motor controller, etc.

As shown, the system 500 can include a power source 513 (e.g., solar, generator, battery, grid, etc.) that can provide power to an edge framework gateway 510 that can include one or more computing cores 512 and one or more media interfaces 514 that can, for example, receive a computer-readable medium 540 that may include one or more data structures such as an operating system (OS) image 542, a framework 544 and data 546. In such an example, the OS image 542 may cause one or more of the one or more cores 512 to establish an operating system environment that is suitable for execution of one or more applications. For example, the framework 544 may be an application suitable for execution in an established operating system in the edge framework gateway 510.

In the example of FIG. 5, the edge framework gateway 510 (“EF”) can include one or more types of interfaces suitable for receipt and/or transmission of information. For example, consider one or more wireless interfaces that may provide for local communications at a site such as to one or more pieces of local equipment, which can include equipment 532, equipment 534 and equipment 536 and/or remote communications to one or more remote sites 552 and 554. In such an example, lesser or more equipment may be included.

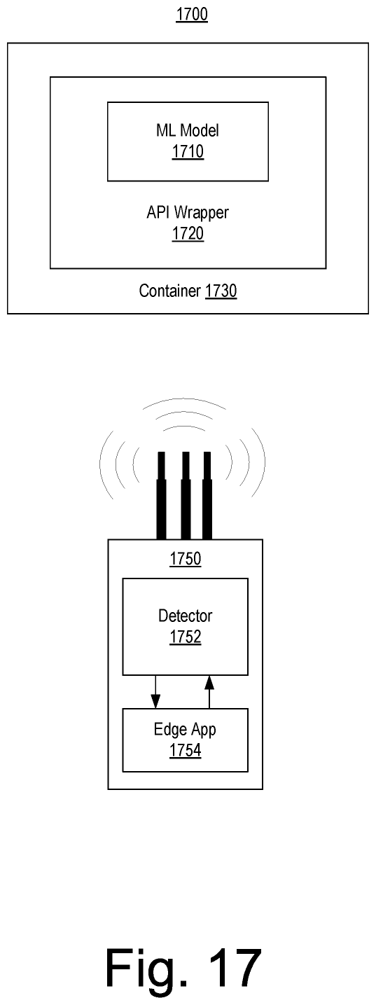

As mentioned, the circuitry 460 of the one or more sensors 416 of the example of FIG. 4 can be utilized as an edge device and/or as part of an edge device. As an example, the circuitry 460 can include and/or host a framework such as the framework 544. As an example, the circuitry 460 can include and/or host containerized instructions (see, e.g., FIG. 17). As an example, the circuitry 460 may be operatively coupled to one or more pieces of surface equipment such as, for example, the edge framework gateway 510 of FIG. 5. As an example, an ESP may be equipped with its own edge computing resources that can, at least in part, operate downhole for monitoring and/or control of the ESP. In various examples, one or more downhole sensors may acquire one or more pressures, one or more temperatures, a drive frequency, etc., which may be inputs to one or more models, monitoring and/or control components, etc.

As an example, the equipment 532, 534 and 536 may include one or more types of equipment such as the equipment 310, the equipment 330, the equipment 350 and the equipment 370 of FIG. 3. As an example, equipment may include non-artificial lift equipment and/or artificial lift equipment.

As an example, the EF 510 may be installed at a site where the site is some distance from a city, a town, etc. In such an example, the EF 510 may be accessible via a satellite communication network and/or one or more other networks where data, control instructions, etc., may be transmitted, received, etc.

As an example, one or more pieces of equipment at a site may be controllable locally and/or remotely. For example, a local controller may be an edge framework-based controller that can issue control instructions to local equipment via a local network and a remote controller may be a cloud-based controller or other type of remote controller that can issue control instructions to local equipment via one or more networks that reach beyond the site. As an example, a site may include features for implementation of local and/or remote control. As an example, a controller may include an architecture such as a supervisory control and data acquisition (SCADA) architecture.

Satellite communication tends to be slower and more costly than other types of electronic communication due to factors such as distance, equipment, deployment and maintenance. For wellsites that do not have other forms of communication, satellite communication can be limiting in one or more aspects. For example, where a controller is to operate in real-time or near real-time, a cloud-based approach to control may introduce too much latency.

As shown in the example of FIG. 5, the EF 510 may be deployed where it can operate locally with the one or more pieces of equipment 532, 534 and 536, etc. As an example, the EF 510 may include switching and/or communication capabilities, for example, for information transmission between equipment, etc.

As desired, from time to time, communication may occur between the EF 510 and one or more remote sites 552, 554, etc., which may be via satellite communication where latency and costs are tolerable. As an example, the CRM 540 may be a removable drive that can be brought to a site via one or more modes of transport. For example, consider an air drop, a human via helicopter, plane, boat, etc.

As explained with respect to FIG. 5, an EF may execute within a gateway such as, for example, an AGORA gateway (e.g., consider one or more processors, memory, etc., which may be deployed as a “box” that can be locally powered and that can communicate locally with other equipment via one or more interfaces). As an example, one or more pieces of equipment may include computational resources that can be akin to those of an AGORA gateway or more or less than those of an AGORA gateway. As an example, an AGORA gateway may be a network device with various networking capabilities.

As an example, a gateway can include one or more features of an AGORA gateway (e.g., v.202, v.402, etc.) and/or another gateway. For example, consider features such as an INTEL ATOM E3930 or E3950 dual core with DRAM and an eMMC and/or SSD. Such a gateway may include a trusted platform module (TPM), which can provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS or another operating system). As an example, a gateway may include a cellular interface (e.g., 4G LTE with global modem/GPS, 5G, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in (e.g., 25 cm×20.3 cm×10.1 cm).

As an example, a gateway may be part of a drone. For example, consider a mobile gateway that can take off and land where it may land to operatively couple with equipment to thereby provide for control of such equipment. In such an example, the equipment may include a landing pad. For example, a drone may be directed to a landing pad where it can interact with equipment to control the equipment. As an example, a wellhead can include a landing pad where the wellhead can include one or more sensors (e.g., temperature and pressure) and where a mobile gateway can include features for generating fluid flow values using information from the one or more sensors. In such an example, the mobile gateway may issue one or more control instructions (e.g., to a choke, a pump, etc.).

As an example, a gateway itself may include one or more cameras such that the gateway can record conditions. For example, consider a motion detection camera that can detect the presence of an object. In such an example, an image of the object and/or an analysis (e.g., image recognition) signal thereof may be transmitted (e.g., via a satellite communication link) such that a risk may be assessed at a site that is distant from the gateway.

As an example, a gateway may include one or more accelerometers, gyroscopes, etc. As an example, a gateway may include circuitry that can perform seismic sensing that indicates ground movements. Such circuitry may be suitable for detecting and recording equipment movements and/or movement of the gateway itself.

As explained, a gateway can include features that enhance its operation at a remote site that may be distant from a city, a town, etc., such that travel to the site and/or communication with equipment at the site is problematic and/or costly. As explained, a gateway can include an operating system and memory that can store one or more types of applications that may be executable in an operating system environment. Such applications can include one or more security applications, one or more control applications, one or more simulation applications, etc.

As an example, various types of data may be available, for example, consider real-time data from equipment and ad hoc data. In various examples, data from sources connected to a gateway may be real-time, ad hoc data, sporadic data, etc. As an example, lab test data may be available that can be used to fine tune one or more models (e.g., locally, etc.). As an example, data from a framework such as the AVOCET framework may be utilized where results and/or data thereof can be sent to the edge. As an example, one or more types of ad hoc data may be stored in a database and sent to the edge.

As to real-time data, it can include data that are acquired via one or more sensors at a site and then transmitted after acquisition, for example, to a framework, which may be local, remote or part local and part remote. Such transmissions may be as streams (e.g., streaming data) and/or as batches. As to batches, a buffer may be utilized where an amount of data may be stored and then transmitted as a batch. In various instances, real-time data may be characterized using a sampling rate or sampling frequency. For example, consider 1 Hz as a sampling frequency that is adequate to track various types of physical phenomena that can occur during well operations. As an example, a sensor and/or a framework may provide for adjustment of sampling (e.g., at the sensor and/or at the framework). In various instances, data from multiple sensors may be at the same sampling rate or at one or more sampling rates. As an example, data sampling can be at a rate sufficient to provide for detection, prediction, etc., as to a probability of occurrence of a solids event at a future time. In such an example, the sooner data are analyzed, the sooner such detection, prediction, etc., can occur. For example, consider a system where advance notice of a risk of a solids event can be greater than 10 minutes, greater than 30 minutes, greater than 1 hour, etc., such that one or more control actions can be taken to mitigate the risk of the solids event.

As explained, various systems may operate in a local manner, optionally without access to a network such as the Internet. For example, a site may be relatively remote where satellite communication exists as a main mode of communication, which may be costly and/or low bandwidth. In such scenarios, security may resort to local features rather than a remote feature such as a remote authentication server.

An authentication server can provide a network service that applications use to authenticate credentials, which may be or include account names and passwords of users (e.g., human and/or machine). When a client submits a valid credential or credentials to an authentication server, the authentication server can generate a cryptographic ticket that the client can subsequently use to access one or more services.

In the example of FIG. 5, the edge framework 544 can be an edge-enabled data processing framework. As an example, such a framework can include features to perform one or more of the followings tasks: real-time data cleansing to synchronize information from existing well metrology (e.g., wellhead, tubing, flow, ESP, etc.); executing one or more machine learning (including self-learning) models in real-time (e.g., one or more ML models that can identify one or more issues, etc.); and conveying a control set point to a controller (e.g., an actuatable valve, etc.) and/or one or more other pieces of equipment. As mentioned, an edge framework may be deployable using downhole circuitry (see, e.g., the circuitry 460 of FIG. 4), which may be downhole circuitry operatively coupled to surface circuitry, etc.

The system 500 can be part of an infrastructure that serves as a secure gateway to transmit surveillance into an operator's surveillance station or its own surveillance platform. The presence of such a gateway can also support an operator for introduction of one or more additional IIOT (industrial internet of things) implementations.

As an example, one or more of the controllers of FIG. 3 and FIG. 4 may include or provide access to one or more frameworks, applications, etc. As an example, one or more of the controllers of FIG. 3 and FIG. 4 can include one or more features of the system 500 of FIG. 5.

As explained, an ESP can be implemented at a site for pumping fluid, whether for injection or production. For example, an ESP may be utilized in a stimulation treatment to inject fluid that includes various chemicals and an ESP may be utilized as an artificial lift technology to assist production of fluid from a reservoir.

As ESPs find various uses in various environments, knowledge as to operation, performance, etc., can be spread amongst various domains where each domain may have its own experts. One type of issue that can arise in ESP operation pertains to presence of an emulsion, which may be formed prior to an inlet to an ESP, near an inlet to an ESP and/or within an ESP. An emulsion is a mixture of two or more fluids that can be immiscible (e.g., unmixable or unblendable) owing to liquid-liquid phase separation where phases include a dispersed phase and a continuous phase. For example, consider an oil in water emulsion where oil is dispersed in a continuous water phase and a water in oil emulsion where water is dispersed in a continuous oil phase. Emulsions can form, be stabilized and/or be destabilized via mechanical, thermal, pressure and/or chemical means. For example, mechanical mixing can result in emulsion formation where stability of the emulsion can depend on factors such as temperature, pressure, surface active agents (e.g., surfactants), salt concentrations, etc. Another type of issue that can arise in ESP operation relates to gas, which can be ingested by an ESP and degrade ESP pumping performance. Gas issues can include, for example, gas degradation and gas lock, which can be due to various types of phenomena, behaviors, etc. Gas degradation may be evident in time series data as one or more signatures which may be prior to or include a low or no flow period. As to gas lock, it is a condition in pumping and processing equipment caused by the induction of free gas where compressible gas can interfere with proper operation of valves and/or other pump components, which may prevent intake of fluid, pumping of fluid, etc.

Issues like emulsion formation and gas issues can occur relatively frequently and cause damage to long-term lifespan of equipment as well as reduction in fluid movement (e.g., injection or production). Existing operational workflows to detect occurrence of such issues tend to be reactive and can be susceptible to human error. As an example, a system can include one or more machine learning models that can be trained such that they learn behaviors that may be exhibited in one or more types of data where, upon detection of a learned behavior or learned behaviors, a trained machine learning (ML) model can output a result, which may be an indicator as to the likelihood of an issue or issues arising (or not arising) during operation of equipment such as an ESP. For example, a trained ML model can receive data as input and output a likelihood of occurrence of a particular issue or issues, where such output may indicate a time frame associated with the likelihood (e.g., or likelihoods with respect to time, etc.).

As an example, a method can include building one or more ML models that can detect if flow constraints like emulsion formation or gas degradation are developing at a pump in real-time by utilizing relatively high frequency ESP sensor data. In such an example, an ML model can be embedded in a data science workflow or workflows. As an example, a system can provide for output generation, which may be directed to a controller, controllers, a dashboard, a network interface, etc. As an example, a system can output one or more alarms, which may be directed to humans and/or machines such that one or more control decisions can be taken, within an appropriate time frame (e.g., in real-time, prior to prediction of occurrence, etc.), which can thereby help to prolong pump life and improve pump operation (e.g., injection, production, etc.).

In machine learning, data are required, which can include actual data and/or synthetic data. In supervised learning, data can be labeled and referred to as labeled data. In unsupervised learning, data may be labeled and/or unlabeled. As to training a ML model, data may be split into one or more groups, which can include training data and testing data. For example, a portion of a dataset can be utilized for training to generate a trained ML model that can then be tested using another portion of the dataset.

In machine learning, overfitting and underfitting can cause poor performance of a machine learning model. In statistics, a fit can refer to how well a target function is approximated. In supervised machine learning, training aims to have a ML model approximate an unknown underlying mapping function for output variables given input variables. Statistics can be utilized to describe goodness of fit which refers to measures used to estimate how well the approximation of the function matches the target function. In machine learning, training can include calculating residual errors, etc.; however, some statistical techniques do not readily as the form of a target function to be approximate may not be known. For example, machine learning can be utilized to train a ML model to approximate an unknown function or functions, which can be referred to as a behavior or behaviors. In various instances, a behavior of equipment interacting with fluid can be challenging to elaborate using a physics-based approach; whereas, through machine learning with appropriate data, a ML model can be trained to learn and model that behavior, at times without a detailed understanding of physics underlying the behavior. As explained, various physics-based simulators can be utilized to simulate behavior, however, these can demand substantial computational resources, which can include large matrixes that can be of orders that can challenge even sophisticated simulators.

As an example, a trained ML model may be built that is relatively light-weight for implementation locally such as via an edge framework. In such an example, local monitoring and/or control can be improved when compared to an approach that relies on sophisticated, physics-based simulation as performed using highly parallelized computational resources.

As mentioned, however, overfitting and underfitting can occur during machine learning such that a trained ML model is either overfit or underfit. An overfit ML model may lack an ability to handle various real-world scenarios (e.g., scenarios on the margins, scenarios that may occur in certain situations, etc.) while an underfit ML model may lack an ability to robustly generate output for generally occurring real-world scenarios. As training demands data, cleanliness, noise, etc., in data can also be issues that are additional to volume of data.

Overfitting refers to a model that models the training data too well. Overfitting happens when a model learns the detail and noise in the training data to the extent that it negatively impacts the performance of the model on new data (e.g., data not previously seen by the model). In overfitting, noise or random fluctuations in the training data can be picked up and learned as concepts by a model where such concepts may not apply to new data and negatively impact the models ability to generalize.

Overfitting tends to be more likely with nonparametric and nonlinear models that have more flexibility when learning a target function. As such, various nonparametric machine learning algorithms also include parameters or techniques to limit and constrain how much detail the model learns. For example, decision trees are part of a nonparametric machine learning approach that tends to be flexible and subject to overfitting of training data. Such a problem can be addressed by pruning a tree after it has learned in order to remove some of the detail it has picked up.

As an example, a method can include building a ML model that utilizes decision trees where one or more tree size related parameters can be honed such that the resulting trained ML model performs suitable for detection of one or more behaviors that can be associated with pump operational issues (e.g., emulsion issues, gas issues, etc.). For example, depth may be a parameter that can be tailored such that a number of layers or decisions or branches to leaves, etc., is appropriately selected.

As to underfitting, it refers to a model that performs poorly on testing data where training data and testing data are from a common dataset as well as an inability to generalize new data. Underfitting may be addressed via data and/or via model selection.

As explained, an appropriate ML model can exhibit desirable performance in a regime between overfitting and underfitting. As an example, a so-called sweet spot can be at a point just before error on a test dataset starts to increase where the ML model has good skill on both the training dataset and the unseen test dataset.

As an example, a method can include using one or more resampling techniques to estimate model accuracy and/or holding back one or more validation datasets. As to resampling, consider k-fold cross validation, which involves training and testing a ML model k-times on different subsets of training data and building up an estimate of performance of the ML model on unseen data. As to a validation dataset, it can be a subset of training data that is held back from machine learning until a latter part of ML model building. For example, after selection and tuning one or more ML models on a training dataset, the one or more ML models can be evaluated using a validation dataset to reach a final objective result as to how well the one or more ML models might perform on unseen data. Cross validation can be utilized for estimating ML model accuracy on unseen data.

As an example, a method for ML model selection and building can generate a trained ML model suitable for use in various pumping scenarios. Such a ML model may be, for example, a nonparametric ML model (e.g., a decision tree model, etc.). As mentioned, a pump such as an ESP can be utilized in a wide variety of pumping scenarios in locations that can include remote locations and in locations where conditions may change. A combination of remote location and possible changing conditions can be an exceptionally challenging pumping scenario to monitor and control.

As explained, a lack of adequate and accurate monitoring of pumps can lead to low efficiency, high lifting costs, and frequent repair and replacements. Analysis of sensor data can demand multiple experts to remain alert. Moreover, given a number of wells with a number of pumps, an analysis demands a well-to-well assessment, which may take hours for a human to perform.

As explained, a ML model-based approach can help to reduce workover time and improve production (e.g., or injection) while extending lifespan of equipment. For example, consider a system that includes components that allow for rapid processing of relatively high frequency sensor data via use of one or more feature engineering techniques and ML models to identify signatures for one or more issues such as, for example, emulsion formation and gas degradation.

As explained, a method can involve supervised and/or unsupervised learning. As explained labeled data may be utilized where data can be labeled by domain experts to capture human knowledge and understanding of one or more types of pump issues that may occur in one or more of various scenarios.

As an example, a system can be implemented in a manner that is modular and customizable and can be set up to learn from past mistakes through a retraining process. As explained, a system may be operable with minimal human intervention and manual analysis (e.g., as implemented for monitoring and/or control) where the system is robust, reliable and proactive and where the system can issue alerts, control signals, etc., for example, responsive to identified behaviors, anomalies, etc. While detection examples include emulsion issues and gas issues, a ML model or ML models may be utilized to detect one or more types of anomalies. For example, an anomaly may be indicated where a signature is neither a normal signature nor an issue signature. In such an example, a system may issue an anomaly alert and may issue one or more control signals, which may depend on operational conditions (e.g., temperature, pressure, flow, etc.). In such an approach, if an anomaly is detected, a system may resort to checking one or more sensor measurements for a trend, a value, etc., which may indicate a heightened risk of failure or other undesirable behavior that may not be known or present in training data. In such an example, retraining may occur and/or generation of a ML model that is specific to the anomalous signature. As explained, a process of continual learning may occur where such learning may be online and/or offline, which may be local and/or remote from a field site.

While a system may be utilized for real-time monitoring and/or control, it may also be used for purposes of assessing historic data. For example, consider a field site with multiple pumps for multiple wells where a trial implementation is commenced for one of the pumps for one of the wells. In such an approach, a ML model that is used to monitor and/or control the one or more of the pumps may be fed data stored as to one or more of the other pumps. For example, consider a scenario where the ML model identifies an emulsion issue for the one pump. In such an example, as a forensic measure, the ML model (or other instance thereof) may be utilized to process data from the other pumps to determine whether the same issue occurred. In such an example, the ML model may be deployed with some assurances that it can detect issues for the other pumps too.

As explained, a system can be local and include a local network where relatively high frequency sensor data can be processed automatically through a data pipeline and can be processed by a ML model workflow, which may operate according to one or more customizable triggers.

As an example, information may be presented in the form of a dashboard, whether local and/or remote. For example, consider a visual dashboard of current and past issues and/or anomalous activities detected along with additional pump performance indicators. As explained, an alert system can provide for automatically sending notifications and alert messages to one or more destinations responsive to detection of one or more issues, anomalies, etc.

As an example, a dashboard may have an option to provide visualizations of sensor data for manual analysis to detect potential issues. In such an example, the dashboard may be supplemented by output from one or more ML models. For example, consider a windowing tool whereby a user can select a window of sensor data for processing by a trained ML model. In such an approach, the trained ML model may provide for signature identification and association such that the user can focus in on what may exist visually within the window of sensor data that can be assessed by the user using the user's expertise and knowledge of physics, etc. As an example, a system can provide a proactive dashboard and one or more ML model workflows that can be utilized to provide alerts as to one or more pump health issues. As explained, a trained ML model may be trained to detect a signature that is a precursor to an issue and may be trained to detect a signature that is representative of an issue. In such an example, a time between the precursor and the issue may be assessed in a manner that depends on one or more phenomena such as flow rate, temperature, etc. For example, in some scenarios, the time or delay may be short when temperature is above a certain level and the time or delay may be longer when temperature is at or below the certain level. Such an approach may provide for more accurately determining a future time of occurrence of an issue given detection of a precursor signature of the issue.

As an example, a system can provide for adaptability, customization, extensibility, etc. For example, a trained ML model may be equipment, field site and application specific or, for example, it may be applicable to various equipment, various field sites and/or various applications. As an example, a trained ML model for one set of criteria may be suitable for supplemental training for use with another set of criteria. For example, a trained ML model may be further trained using data from another field site such that the resulting retrained ML model can identify behaviors of a pump at the other field site. As an example, particular equipment and/or instruments may vary from field site to field site such that inputs to a ML model depend on specifics of a field site. In such an example, a ML model may be adapted to operate on lesser, more and/or different input(s). As an example, a system may provide for one or more of customized alarms, adjustable issue detection sensitivity through probability thresholds, selectable ML workflows and selectable visualization dashboard features.

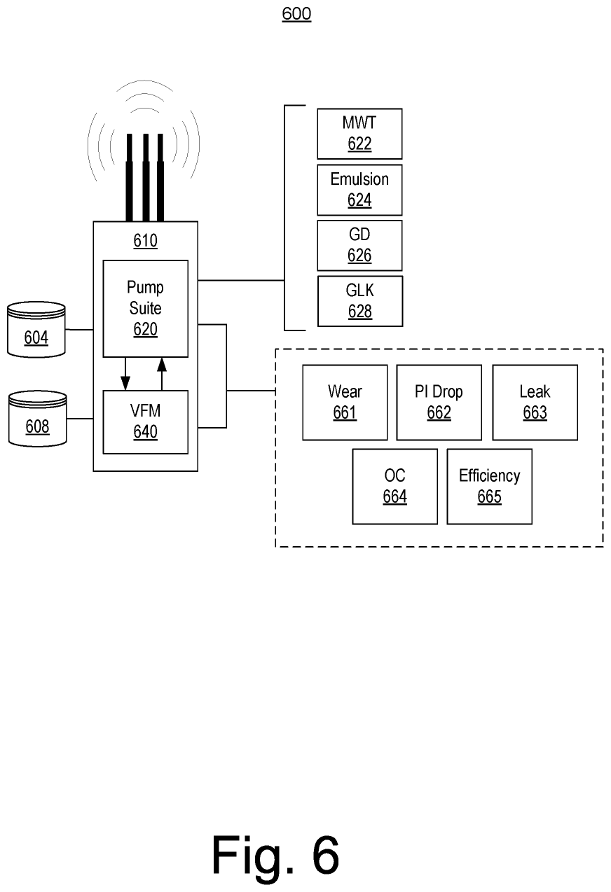

FIG. 6 shows an example of a system 600 that can be implemented locally at a field site. As shown, the system 600 can be operatively coupled to one or more data sources 604 and 608, which can include pump data and/or sporadic data. As shown, an edge device 610 (e.g., an edge gateway, etc.) can include components germane to monitoring and/or control of pump equipment. For example, the edge device 610 can include a pump suite component 620 and a virtual flow meter (VFM) component 640. The edge device 610 can provide for generation of information regarding operation of an ESP where such information can include information as to motor winding temperature (MWT) 622, emulsion 624, gas degradation (GD) 626 and gas lock (GLK) 628. As shown in the example of FIG. 6, the system may also provide information as to wear 661, productivity index (PI) drop 662, leakage 663, operational condition 664 and efficiency 665. In FIG. 6, the blocks 622, 624, 626, 628, 661, 662, 663, 664 and 665 can be alarm and/or control blocks that provide for issuance of one or more of an alarm and a control signal (e.g., a control command, etc.).

In the example of FIG. 6, the pump suite 620 can be a suite of specialized components for real-time ESP alarms and/or control, which may be enabled through data analytics and an edge-based multiphase flow simulator. For example, the system 600 can provide for continuous monitoring of one or more ESPs to help ensure optimal pump working conditions, which can help to avoid deferred oil production. As wells around the world age and experience decreased production (e.g., due to decreasing reservoir pressure, etc.), artificial lift can be increasingly utilized to assist production from such wells. With the increased population of ESPs deployed worldwide, the system 600 can be a comprehensive alarm triggering and/or control system that is part of an oilfield production surveillance strategy. As explained, issues may be identified using data analytics, which can generate one or more types of models for issue detection. In such an approach, one or more physics-based simulators may be utilized in conjunction with one or more of such models. For example, consider a relatively light-weight simulator that can be deployed at the edge where such a light-weight simulator may include a honed-down version of an actual simulator and/or one or more proxies (e.g., trained ML model proxies, regression model proxies, etc.). As an example, the VFM component 640 may include an edge deployable version of the PIPESIM simulator.

As an example, a suite of components may include, for example, one or more of a gas degradation component, a GLK component, an emulsion component, a MWT component, a pump upthrusting/downthrusting component, a pump wear component, a productivity index (PI) drop component and a tubing leak component. In such an example, each component can be tailored to target a specific potential suboptimal pump working condition.

As an example, a suite of components can include various types of components, which may include hybrid types. As an example, a pure data-driven approach may be utilized that can apply one or more machine learning models such as logistics regression, k-means clustering, continuous linear regression, etc. As an example, a workflow may utilize an edge-enabled steady-state multiphase flow simulator to calibrate a model against sporadic data. In such an example, a coupled VFM can output calculated flow rates that can be further used to flag status with respect to one or more of different alarm and/or control categories.

As an example, for an ESP application, real-time ESP sensor data, such as pump intake pressure (PIP), can be received by a system at a suitable frequency (e.g., sampling rate, etc.). For example, consider a one-minute frequency. As an example, for gas degradation (GD), gas lock (GLK), emulsion and MWT, one or more ML modeling approaches can be directly applied to flag each timestamp.

For example, for a GLK alarm, pump intake pressure (PIP), pump discharge pressure (PDP) and motor operational frequency can be combined in rolling windows of a desired duration for detection of whether gas locking is present, for example, given a trend of a regression and a fluctuation of a signal. As an example, one or more additional rule-base constraints, such as, for example, Pearson correlation of PDP and/or PIP, may be applied in an effort to reduce the likelihood of potential false alarms. As an example, one or more cut-off values may be determined using a technique such as k-means clustering based upon historical labeled events. As explained, for various detectors, sporadic data may be used when available where each well test of a well may be utilized to calibrate an updated well model in real-time and calculate parameters such as derating factor. As an example, an edge-based VFM can provide for calculation of different types of flow rates using inflow and pump performance curve separately, while a combined trend can detect particular signatures for PI drop and tubing leak.

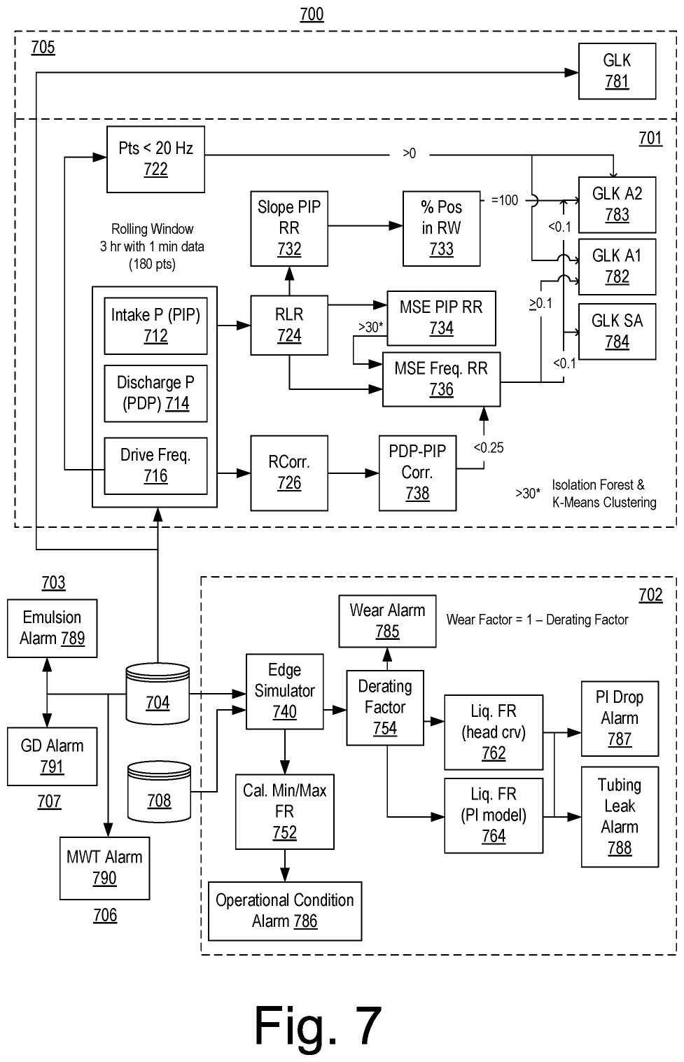

FIG. 7 shows an example of a system 700 that can be implemented for an ESP at a field site where various types of data are available as indicated by data sources 704 and 708 where the data source 704 can provide real-time ESP sensor data and where the data source 708 can provide sporadic data (e.g., from a well test or well tests, etc.). In the example of FIG. 7, the system 700 can be defined as including various combinations of monitoring and/or control features 701, 702, 703, 705, 706 and 707 operatively coupled to one or more of the data sources 704 and 708. As shown, the data source 704 can provide pump intake pressure (PIP) data 712, pump discharge pressure (PDP) data 714 and drive frequency data 716. Such data may be directed to an edge simulator 740, a GLK component 781, an emulsion alarm component 789, a MWT alarm component 790 and/or a gas degradation (GD) component 791. As explained, the edge simulator 740 may utilize sporadic data, for example, from the data source 708. In the example system 700, various components can form a suite of components for monitoring and/or control, which may, for example, be selected for a particular pump or pumps for one or more wells.

As to an example of a virtual flow meter (VFM), consider technologies and techniques described in a US provisional application having Ser. No. 63/218,180, filed 2 Jul. 2021 (′180 application), which is incorporated by reference herein. The ′180 application describes an ESP VFM that can calculate in real-time the flow rate of a well using different types of input, as may be acquired using sensors, etc., where output may include one or more of liquid flow rate (QI), oil flow rate (Qo) and water flow rate (Qw), where QI can be a sum of Qo and Qw. Such an approach can provide for an increased frequency of flow rate knowledge (e.g., real-time versus once every two weeks or every month). The ′180 application also describes a computation of a productivity index (PI) using the VFM (e.g., a PI VFM) along with utilization of a VFM for one or more purposes such as, for example, to detect leaks and scale precipitation, corrosion, etc.

As an example, a system may include features that pertain to chemical injection. For example, a published US application having publication number US 2021/0293,141 A1, as published 23 Sep. 2021 (′141 application), which is incorporated by reference herein, describes a chemical injection system for a resource extraction system that includes a controller having a memory and a processor where the memory can store instructions that cause the processor to receive a first pressure from a first pressure sensor of the resource extraction system, receive a second pressure from a second pressure sensor of the resource extraction system, determine a flowrate of a produced fluid of the resource extraction system based on the first pressure and the second pressure, determine an ion concentration of the produced fluid, and adjust an injection rate of a chemical into the resource extraction system based on the flowrate of the produced fluid, the ion concentration of the produced fluid, or both. In such an approach, one or more types of pumps may be utilized that can be controlled for one or more purposes, which may be in response to one or more conditions.

As shown in the example of FIG. 7, various types of alarm and/or control components can be provided and implemented, optionally in a selectable manner, which may be automatically, semi-automatically or manually selected. In particular, such components include the GLK component 781 as the feature 705, a GLK A1 component 782, a GLK A2 component 783 and a GLK suspicious activity (SA) component 784 as the features 701, a wear component 785, an operational condition component 786, a PI drop component 787 and a tubing leak component 788 as the features 702, the emulsion component 789 as the feature 703, the MWT component 790 as the feature 706 and the GD component 791 as the feature 707. As shown, the features 702 can utilize the edge simulator 740, which can receive data from the data sources 704 and 708, while the features 701, 703, 705, 706 and 707 can receive data from at least the data source 704.

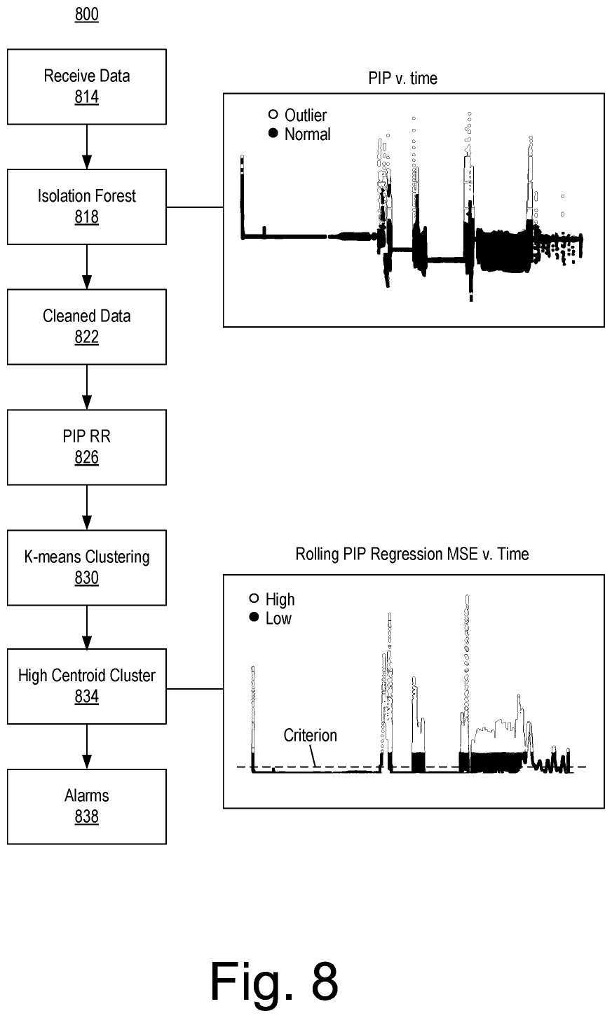

In the example of FIG. 7, the features 701 include a rolling window block 722 that can operate using the drive frequency data 716 and that can utilize one or more criteria for effectuating the GLK A1 component 782 and/or the GLK A2 component 783, either of which can also receive information from one or more other components. For example, a rolling linear regression (RLR) component 724 can generate output using the data 712, 714 and/or 716 for receipt by a 5 point slope of PIP rolling regression (RR) component 732, for receipt by a mean squared error (MSE) PIP rolling regression (RR) component 734, and for a MSE frequency rolling regression (RR) component 736. As shown, the component 732 can provide output to a percent positive in rolling window (RW) component 733 where, for example, if the percent positive is equal to 100 percent, output of the component 733 can be directed to the GLKA2 component 783. As shown, the MSE PIP RR component 734 can provide output to the MSE frequency RR component 736, which may also receive input via a rolling correlation (RCorr.) component 726 that feeds a PDP-PIP correlation component 738. In the example of FIG. 7, the output of the PDP-PIP correlation component 738 can trigger the MSE frequency RR component 736 according to a criterion such as, for example, a correlation less than 0.25; noting that, under substantially normal operation, the PIP and the PDP can be expected to be correlated such that a low correlation can indicate a possible issue. As to the MSE PIP RR component 734, it can trigger the MSE frequency RR component 736 if a criterion is exceeded where the criterion can be, for example, based on an isolation forest and k-means clustering assessment (e.g., consider a criterion of greater than 30 as a cutoff value as to the output of the MSM PIP RR component 734; see also FIG. 8). As shown, output of the MSE frequency RR component 736 can be assessed to trigger one or more of the GLK A1 component 782, the GLK A2 component 783 and the GLK SA component 784; noting that the GLK A1 component and the GLK A2 component 783 can each receive multiple inputs (e.g., germane to the type of behavior to trigger an alarm or alarms). In the example of FIG. 7, the criteria on the output of the MSE frequency RR component 736 include less than 0.1 and greater than or equal to 0.1 where a value less than 0.1 triggers the GLK SA component 784 while also being considered in a logical assessment for the GLK A2 component 783 along with output from the components 722 and 733. In such an example, three types of gas lock monitoring alarms and/or control actions can be triggered using the set of features 701.

As to the set of features 702, these can include the edge simulator 740, which can provide output to a calibrated minimum and/or maximum flow rate (FR) component 752, which can trigger the operational condition alarm component 786 for appropriate issuance of an alarm and/or a control action, and can also provide output to a derating factor component 754, which can trigger the wear alarm component 785 for issuance of an alarm and/or a control action (e.g., consider a wear factor defined using a derating factor such as the wear factor equals 1 minus the derating factor). As to the derating factor component 754, it can provide output to one or more components 762 and 764 for liquid flow rate (FR) that can utilize one or more types of models (e.g., a head curve model, a production index (PI) model, etc.). As shown, the one or more components 762 and 764 can trigger one or more of the PI drop alarm component 787 and the tubing leak alarm component 788, which can provide for issuance of one or more alarms and/or one or more control actions.

As to the feature 703, it can include a ML model-based approach to trigger the emulsion alarm component 789, which can issue an alarm and/or a control action. As to the feature 705, it can include logic and/or a ML model for triggering the GLK component 781, which can issue an alarm and/or a control action. As to the feature 706, it can include logic for triggering the MWT alarm component 790, which can issue an alarm and/or a control action. As to the feature 707, it can include a ML model-based approach to trigger the GD alarm component 791, which can issue an alarm and/or a control action.

As explained, the system 700 can include a suite of features that may be selectable automatically, semi-automatically or manually. In FIG. 7, the system 700 pertains to operations of a pump such as, for example, an ESP, noting that a system may provide features for one or more other types of pumps, multiple pumps, etc.

As explained, the system 700 can include various features that can be utilized to perform various workflows, which may be performed continuously or on-demand in a real-time manner on real-time data and/or in a historical assessment manner on historical data. As explained, such a system can combine ML model-based approaches with rule-based criteria and robust wellbore modeling (e.g., edge-based simulation) to raise awareness of the ESP performance conditions, which may trigger one or more types of control. In such an approach, the injection of domain expertise and physical modeling into AI-based workflows can improve robustness of a system and reduce false alarms (e.g., and unnecessary control actions) with limited data exposure. The completeness of a suite of alarms can provide for more comprehensive monitoring of assets and reduce the risk of lost production time, lost injection time, etc.

Various features can provide for early stage detection of anomalies in operation of a pump and allow a human and/or a machine (e.g., a controller) a sufficient amount of time to perform one or more control actions, which may help to reduce unnecessary shutdowns (e.g., non-productive time, etc.).

As explained, a system can provide for an understanding of operational conditions of ESP assets in real-time, which can facilitate proper operation, particularly at remote field sites. In such an approach, demand for human intervention by travel to a field site may be reduced while also providing assurances as to proper operation to meet various goals. As explained, edge-based computing resources may be utilized for real-time computations, which may be utilized for monitoring and/or control. As explained, executable instructions can be stored in memory for deployment on a gateway, which may be coupled with an edge-based simulator (e.g., PIPESIM simulator on the edge, etc.). As explained, one or more ML model frameworks may be implemented using a gateway or other edge-based computational resources.

As explained, a system can provide for substantially continuous monitoring and/or control of a pump to help ensure optimal pump working conditions. As explained, a system can include various data analytics driven components where one or more may be integrated with a VFM deployed on the edge. Various components may implement a data-driven approach that may include application of one or more ML models (e.g., logistics regression, k-means clustering, continuous linear regression, decision trees, etc.). As explained, a VFM can include an edge-enabled steady-state multiphase flow simulator to calibrate one or more models against sporadic data. As an example, a coupled VFM can output one or more calculated flow rates that can be used, for example, to flag a status with respect to one or more of different alarm categories.

As an example, the MWT alarm component 790 of FIG. 7 can detect one or more types of abnormal changes in motor winding temperature of a pump during pump operation. Abnormal and abrupt changes in MWT can severely damage one or more electrical components of a pump and its motor, leading to a potential system failure and unnecessary workovers. As an example, the MWT alarm component 790 may consume different channels of sensor data where such sensor data can be utilized to train a ML model such as, for example, a random forest ML model. In an example trial, a random forest model was trained using sensor data for pumps deployed at three wells where the data provided indications of historical events tracked during real operations. In the example trial, three data channels were utilized, specifically, MWT, ESP drive frequency and average amperage. The training data were manually labeled by experts following the logic that, when the MWT increases while the average amperage and the drive frequency stay constant, an alarm is to be triggered. On top of the three ESP sensor data channels, 1 hour rolling differences for each of the three data categories were also included as features for the ML model. A correlation matrix of the included features demonstrated good feature independence. In the training process, the testing wells data were separated with 30 percent used for testing and 70 percent used for training. The ML model provided a testing F1-score close to 99 percent, demonstrating ML model accuracy. As an example, such a ML model can be packaged using an application programming interface (API) within a container where the container can be deployed to field computing equipment (e.g., an edge device, etc.) for real-time use and/or further training.

As to the various GLK alarm components 782, 783 and 784, these can help to reduce instances of gas locking during pump operation. Gas locking may occur due to a gas slug that causes the amount of gas at a pump intake to increase, or due to a condition or conditions that cause a pump to produce more head than it can. As indicated in the example system 700 of FIG. 7, three different GLK alarm components can be provided, which can include normal gas lock (see the GLK A2 component 783), gas lock when the pumping unit includes a Proportional-Integral-Derivative (PID) controller (see the GLK A1 component 782), and suspicious gas lock with emulsion potential (see the GLK SA component 784). The GLK A2 normal gas lock component 783 operates according to a condition when intake pressure (PIP) is consistently increasing due to the accumulation of gas (e.g., via a slope, etc.). On the contrary, if a pump VSD includes a PID controller, the PID controller can automatically adjust the frequency when gas locking starts, leading to fluctuating frequency and intake pressure, which is handled by the GLK A1 component 782. Another similar condition is that, if there is a potential of emulsion formulation, the intake pressure may still fluctuate even when at a constant drive frequency. Such a condition can be the basis for a suspicious gas lock condition, which may be cross-checked against one or more emulsion detection features (e.g., the emulsion alarm component 791) for confirmation. As explained, the GLK SA component 784 can handle the suspicious scenario, optionally with coupling to the emulsion alarm component 789.

As shown in the example of FIG. 7, the features 701 can utilize PIP 712, PDP 714 and drive frequency 716 as input data channels. Depending on various factors, data may be limited for purposes of training one or more ML models. For example, consider insufficient labeled data for purposes of supervised learning. In the example of FIG. 7, the features 701 may utilize a hybrid approach that can serve as a first path for alarm triggering as well as generating a labeled dataset for ML model training. In such a hybrid approach, a handoff may occur once sufficient labeled data are available for robust training of one or more ML models.

As an example, a hybrid workflow can include use of rolling regression (RR) and Pearson correlation calculations for input data channels. As explained, a rolling window can be set to three hours, as may be determined by offline testing. Such an approach can also reduce the potential for false alarms associated with pump start-up by detecting ultra-low frequency points within a rolling window. As for one or more cutoff values used for such an alarm, a ML-based offline workflow may be implemented. For example, one cutoff can be for the value for pump intake pressure (PIP) rolling variance where a threshold value is determined as follows: (a) implementation of an isolation forest algorithm that removes outliers in a dataset, and (b) k-means clustering (e.g., with two clusters, k=2) to differentiate groups with high and low rolling variances. In such an example, a high variance represents fluctuating intake pressure conditions, corresponding to gas locking under PID condition or suspicious gas locking.

In an example trial, such an approach was implemented using data for four wells, each with an ESP and associated ESP sensor data as recorded over a three month period of time. The approach provided an overall accuracy of approximately 84 percent for the limited amount of data when benchmarked against expert labeled results.

FIG. 8 shows an example of a method 800 that includes a reception block 814 for receiving data, an isolation forest block 818 for applying an isolation forest to generate results for outliers and non-outliers, a cleaned data block 822 for cleaning the received data using the results of the isolation forest block 818, a PIP rolling regression block 826, a k-means clustering block 830 for applying a k-means clustering technique to results of the PIP rolling regression block 826 to generate a high cluster and a low cluster, a high centroid cluster block 834 that selects the high cluster of the k-means clustering block 830 and an alarm block 838 that can provide for determining an alarm of the GLK A1 component 782 and/or an alarm of the GLK SA component 784. In an example trial, the low cluster (e.g., lower group centroid) was approximately 18 and, by combing trials for other wells, a cut off value was set to approximately 30 (e.g., greater than 30 to be included in a high cluster). Such an approach provided agreement with benchmark event labeling. As an example, a graphical user interface can be generated by a system that indicates alarm type and status versus time. As explained, a hybrid approach can be compared to expert labels to determine accuracy and, for example, a hybrid approach can be utilized to generate labels automatically such that additional labels are available, which may be utilized in one or more ML model based approaches for supervised training of one or more ML models, which may supplant and/or supplement a hybrid approach to monitoring and/or control.

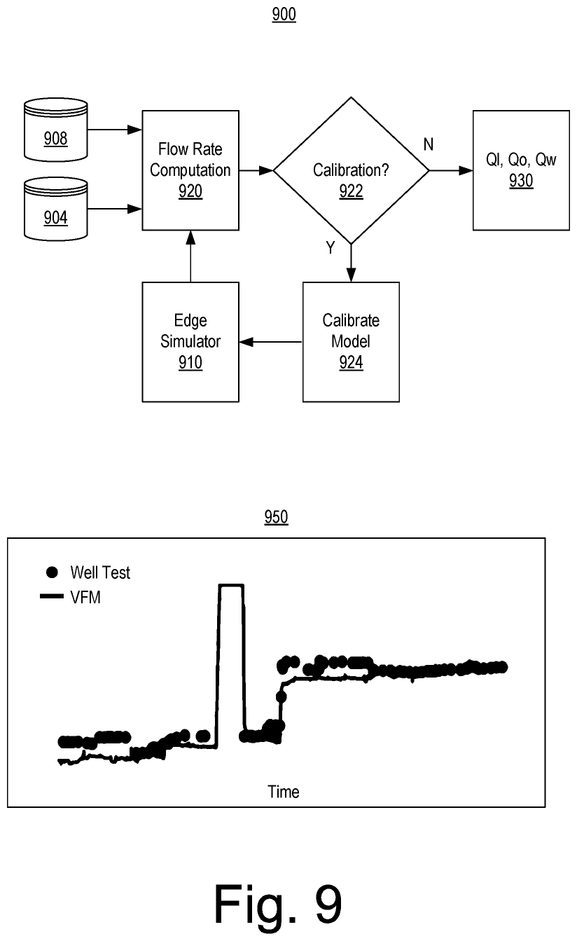

FIG. 9 shows an example of a virtual flow meter (VFM) 900 as operatively coupled to data sources 904 and 908, where the data source 904 can provide real-time data such as, for example, intake pressure, discharge pressure, intake temperature and drive frequency and where the data source 908 can provide sporadic data such as, for example, model building data (e.g., pump type, number of stages, etc.) and simulation and calibration data (e.g., liquid rate, water cut, American Petroleum Institute fluid characterization values, etc.). As explained, sporadic data may be from well testing, lab testing, equipment selection, etc. As mentioned, various examples of a VFM are described in the ′180 application, which is incorporated by reference herein.

As shown in the example of FIG. 9, the system can include an edge simulator 910 that is operatively coupled to a flow rate computation block 920 where a decision block 922 can decide whether a model is to be calibrated. As shown, where the decision block 922 decides that calibration is appropriate, the system 900 can utilize a model calibration block 924 to provide for calibration of a model for the edge simulator 910. As indicated, where the decision block 922 decides that calibration is not required, the system 900 can include an output block 930 that can output one or more flow rate values such as, for example, one or more of QI, Qo and Qw. As explained with respect to the system 700 of FIG. 7, an edge simulator can be the edge PIPESIM simulator 740. In the example of FIG. 7, the edge PIPESIM simulator block 740 can include features of the system 900 of FIG. 9 and optionally additional features.

FIG. 9 also shows an example plot 950 of well test data and computed flow data from the system 900. As shown, well test data can be sporadic, which may be available from a monthly well test. If a computed flow rate differs considerably from a previously measured flow rate (e.g., according to one or more criteria), the system 900 can proceed to calibration and/or be taken offline until calibration is suitably performed.

As explained, flow rate enables diagnosing multiple unfavorable conditions. However, a physical flow meter may not be installed at a field site or may be installed for short periods of time such as, for example, during a well test, etc. As explained, a VFM can utilize a multiphase flow simulator adapted to run at the edge to compute flow rates using sensor data as to differential pressure across a pump and/or a differential pressure including a reservoir level. In such examples, calibrated pump curves may be utilized to better represent the flow across a pump and/or a simplified inflow performance relationship (IPR) curve may be utilized. As shown in the example system 700 of FIG. 7, the blocks 762 and 764 provide for use of a head curve model or a production index model, where the former may be a pump curve and the latter an inflow performance relationship (IPR) curve. As an example, a head curve based approach can involve fewer uncertain variables and exhibit an ability to keep its representativeness even when facing changes in frequency, fluid properties, flow conditions, and reservoir deliverability. As shown in FIG. 7, two approaches can be utilized, which can provide information relevant to the PI drop alarm component 787 and/or the tubing leak alarm component 788. Further, a VFM may be utilized to provide information relevant to the operational condition alarm component 786.

As an example, a VFM may be utilized for computing water production and comparing to actual water production, monitoring for unstable flow caused by a high gas to oil ratio (GOR), monitoring production loss via computed VFM values, etc.

As an example, calibration of an edge simulator may be performed responsive to availability of sporadic data, which may be generated locally and/or remotely via machine and/or human. As an example, an ESP pump performance curve can be calibrated with updated pump rate and head derating factors. As an example, a reservoir IPR model can be updated to reflect a current inflow condition or conditions. As explained, two types of flow rates can be computed using an edge simulator: a head based flow rate and an IPR based flow rate.

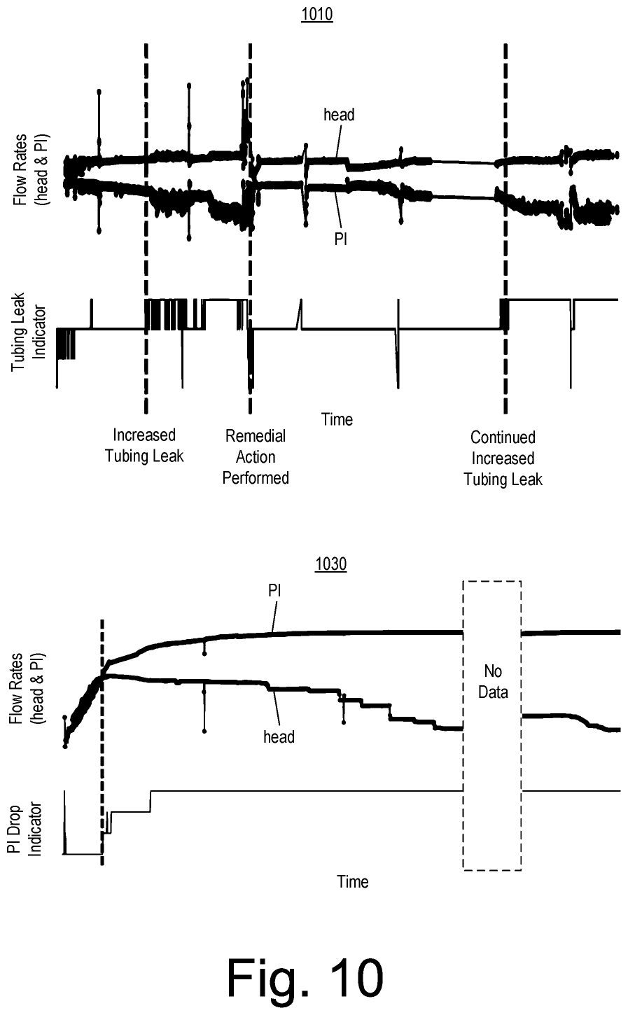

FIG. 10 shows example plots 1010 and 1030 where values for a head based flow rate and an IPR based flow rate are plotted with respect to time along with a tubing leak indicator in the plot 1010 and a performance index drop indicator in the plot 1030. As shown, the values can provide for detection of tubing leakage, remedial action and a performance index drop.

Calibration of ESP and IPR components may or may not be synchronized, noting that calibration of a pump performance curve can happen more frequently. In such an example, a head based flow rate can be more up to date, and can be used in combination with a performance curve to estimate one or more alarms such as, for example, a pump wear alarm, a pump efficiency alarm and a pump operating condition alarm. A VFM calibration process can directly yield an updated pump derating factor (see, e.g., the derating factor block 754 of FIG. 7), which can provide output for a pump wear alarm (see, e.g., the pump wear alarm component 785), for example, when compared against a preset threshold value that may be determined by an expert. A head based flow rate may be compared against an operational envelope at a real-time current frequency to determine whether a pump is upthrusting or downthrusting (e.g., as an operational condition). As an example, pump efficiency may be computed in real time using a pump performance curve as well as using one or more polynomial factors. Various metrics may be computed using physics-based rules of an edge framework that enables on-the-fly evaluation of operational condition of a pump (see, e.g., the operational condition alarm component 786 of FIG. 7).

As explained, a head based flow rate and an IPR based flow rate can be utilized for monitoring and/or control. In such an approach, trends may be utilized where each type of flow rate can be analyzed for what it may contribute to a trend for purposes of detection of a condition, an anomaly, etc. Referring again to the plots 1010 and 1030 of FIG. 10, the plot 1010 demonstrates a leak alarm technique and the plot 1030 demonstrates a production index drop technique for monitoring and/or control. Theoretically, when a tubing leak happens, the pressure drop across a pump intake and a pump discharge will decrease drastically, yielding a fast-decreasing pump head. When this abnormal pump head is fed to an edge simulator (e.g., an edge VFM), an increase in a head based flow rate value occurs. On the other hand, as pump intake pressure increases, an IPR based flow rate decreases due to the decreased pressure drop inside the reservoir. Therefore, when a tubing leak occurs, a divergence in the two flow rates computed via a VFM can be detected for example, where a head based flow rate increases and an IPR based flow rate decreases (see, e.g., the plot 1010).

As shown in the plot 1010, the two flow rates diverge even at the beginning of a given period, indicating a developing tubing leak condition. In an example trial, this trend matched field observation. Further, in the plot 1010, over a period of time the two flow rates converge and the tubing leak indicator decreased by one level. This too matched field observation as to a remedial action taken for that time period. Hence, a tubing leak alarm can detect a leak event and also the degree of a leak, whether the situation is improving or deteriorating.

As shown in the plot 1030, the two flow rates can be utilized to detect whether a productivity drop is developing in a reservoir. Theoretically, when productivity is dropping, especially when due to damage in a near-wellbore area, a skin factor in an IPR model can increase, leading to decreased pump intake pressure and flow bottom hole pressure. Given a stable reservoir pressure, an IPR based flow rate value would be expected to increase if no calibration has been performed. On the other hand, a head based flow rate would be expected to decrease as the pressure drop across the pump would be expected to increase. In the plot 1030, a production index drop is shown through use of the two different flow rate computations, which can be performed locally at a wellsite using a VFM. Specifically, after calibration, productivity continuously decreases as detected by the PI drop alarm, which is in accordance with field observation. In such an approach, the PI drop alarm can aim to detect a drop in productivity after a most recent IPR calibration. To track a productivity trend across a longer period, calibrated IPR model parameters may be interrogated, which may provide for an indication of robustness and/or reliability of a PI drop alarm.

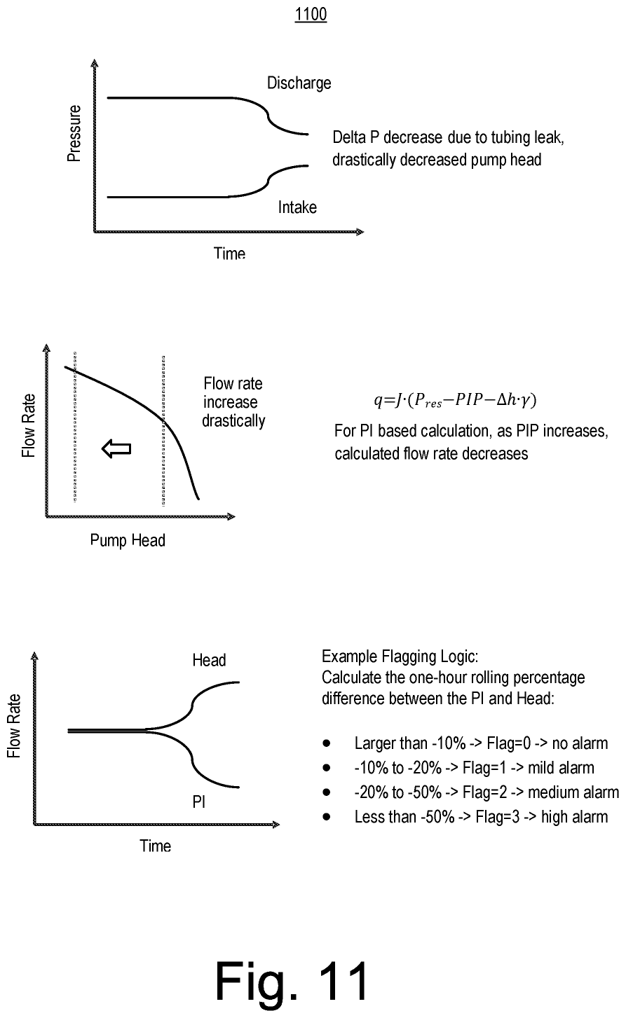

FIG. 11 shows a series of diagrams 1100 associated with an approach to leakage detection. As explained, a differential pressure between an intake and an outlet (discharge) can decrease due to a tubing leak such that there is a drastically decreased pump head. Further, for a PI base computation, as PIP increases, the computed flow rate can decrease. As to detection logic, an approach can include, for example, computing a one-hour rolling percentage difference between a PI based computation and a head based computation for flow rates where a no alarm level, a mild alarm level, a medium alarm level and a high alarm level may be set by using appropriate thresholds.

In the example of FIG. 11, an equation is given for flow rate (q), which depends on productivity index (J or PI), reservoir pressure (Pᵣₑₛ), PIP, height differential (Δh) and specific gravity (γ):

$$q = J \cdot ( {P}_{res} - PIP - Δ h \cdot γ ) .$$

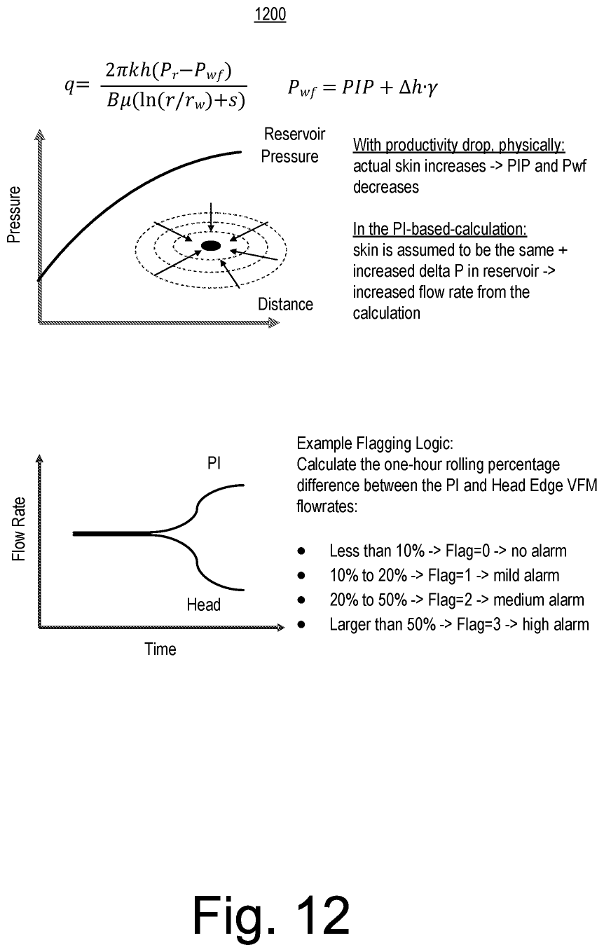

FIG. 12 shows a series of diagrams 1200 associated with an approach to production index (PI) drop detection. As explained, with a production drop, actual skin factor can increase where PIP and P_{wf} decrease. In a PI based computation for flow rate, the skin factor can be assumed to be the same with an increased differential pressure in a reservoir, which leads to an increased flow rate value from the PI based computation. As to detection logic, an approach can include, for example, computing a one-hour rolling percentage difference between a PI based computation and a head based computation for flow rates where a no alarm level, a mild alarm level, a medium alarm level and a high alarm level may be set by using appropriate thresholds.

In the example of FIG. 12, an equation is given for flow rate (q), which depends on flowing bottom hole pressure (P_{wf}), radii (e.g., drainage radius, r, and wellbore radius, r_{w}), pressure at radius r (Pᵣ), viscosity (μ), permeability (k), formation volume factor (B), PIP, height (Δh), specific gravity (γ), and skin factor (s):

$$q = \frac{2 π kh ( {P}_{r} - {P}_{wf} )}{B μ ( ln \frac{r}{{r}_{w}} + s )}$$

$$where$$

$${P}_{wf} = PIP + Δ h \cdot γ .$$

As explained, model calibration can be performed using a pump performance curve calibration that may provide derating factor and an updated operational envelope and can be performed using a Darcy's law-based model for reservoir flow, which may provide a calibrated IPR relationship by adjustment of a skin factor. As explained, flow rate computations can include one or more of a head curve based computation utilizing a calibrated pump performance curve and a PI based computation utilizing a calibrated Darcy's law based IPR model.

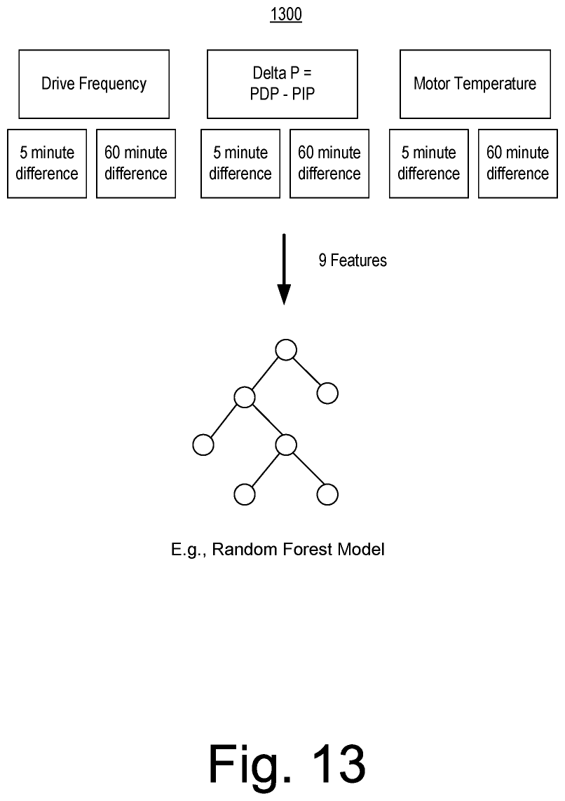

FIG. 13 shows an example of a ML model approach to leak detection 1300. In the example of FIG. 13, data such as three channels of ESP data can be acquired where time differences can be utilized to compute features. As shown, the example approach 1300 provides for computation of nine different features, three raw values and six time difference values. Such features may be utilized for building a random forest model, which may, for example, run in the background and be improved with more labeled events. As explained, an approach to detection can transition from one technique to another where a latter technique may implement a ML model, which may be trained via supervised labeling, whether by human and/or machine. While the example ML model approach 1300 of FIG. 13 is described with respect to leak detection, such an approach may be employed for one or more other alarms (e.g., PI drop, GLK, MWT, etc.).

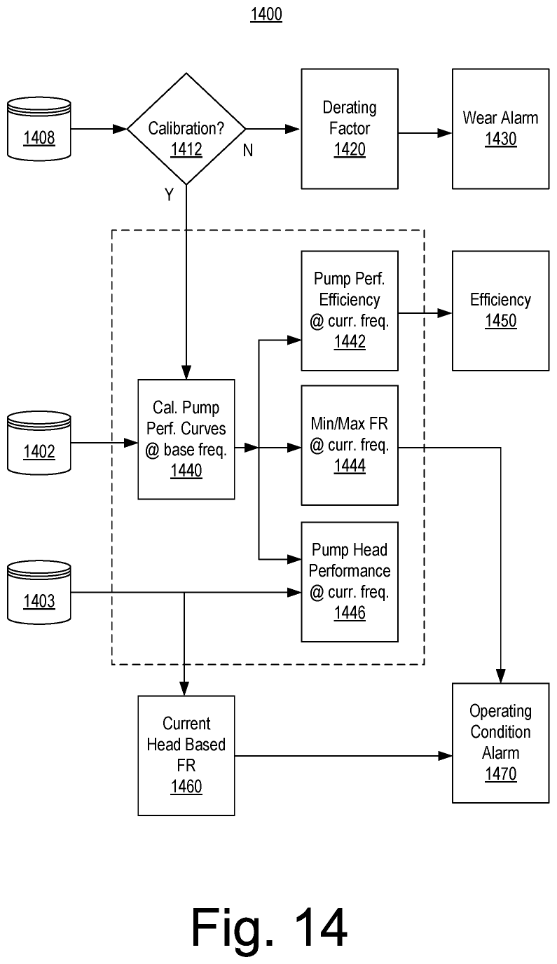

FIG. 14 shows an example of a system 1400 that includes various outputs including one or more alarms. As shown, the system 1400 can be operatively coupled to one or more data sources 1402, 1403 and 1408, which can include a pump drive frequency data source, a pump PIP and PDP data source and a well test data source, respectively. As shown, the data source 1408 can trigger a decision block 1412 to decide whether to perform a VFM calibration, which can utilize one or more affinity laws and data from the data sources 1402, 1403 and 1408. As shown, where the decision block 1412 decides not to calibrate, the system 1400 can proceed to output a derating factor 1420 for assessment by a pump wear alarm component 1430. Affinity laws express mathematical relationships between several variables involved in pump performance and may be used to make predictions, for example, as to what effect speed, impeller diameter, etc., may have on centrifugal pump performance. As an example, a process may trim an existing impeller where affinity laws will apply to conditions for the trimmed impeller.

As to the calibration process, it can include a calibrated pump performance curves block 1440 for performance curves at a base frequency of a pump. For example, consider an ESP that has its motor set to operate at a base frequency (e.g., a base drive frequency). As shown, the block 1440 can inform blocks 1442, 1444 and 1446 as to pump performance efficiency at a current frequency, minimum and maximum flow rate at the current frequency, and pump head performance at the current frequency, respectively. As to the pump head performance at the current frequency block 1446, it can utilize data from the data source 1403, which, as mentioned, can provide PIP and PDP values. Additional outputs of the system 1400 can include efficiency via an efficiency component 1450, current head based flow rate per a current head based flow rate component 1460 and one or more operating condition alarms per an operating condition alarm component 1470. As an example, the system 700 can include one or more features of the system 1400 of FIG. 14.

As explained, a system can include edge components deployed locally at a wellsite, which may be suitable for handling tasks for more than one well. As an example, a system may be suitable for annular gas handling, which is an automated process to handle high gas wells to enhance production; for sucker rod pump implementation to provide real-time surveillance and remote control; for visual analytics to monitor one or more flares remotely including, for example, flare gas volume measurements with or without a meter; for predictive health maintenance (PHM) of a horizontal pump system with one or more sensors connected to an edge device; for multiphase flowmeters with real-time monitoring and remote actions in combination with pump surveillance; for early events detection that can affect one or more pump related alarms.

In example trials, a system that included features of the system 700 of FIG. 7 demonstrated an ability to improve oil production by 12 to 30 percent, an ability to reduce field crew visits to wells by over 95 percent, and an ability to improve a carbon footprint, for example, counting over 4 kilometers not traveled with an associated 0.75 tons of CO2.

As explained, issues like emulsion formation and gas degradation can occur frequently and cause damage to long-term lifespan of equipment as well as reduction in production and/or injection. As explained, a system can include various features for utilization of one or more ML models built to detect if flow constraints like emulsion formation or gas degradation are developing at a pump in real-time, for example, by utilizing relatively high frequency ESP sensor data.

As to data acquisition, relatively high frequency time series signal data can be acquired during operation from ESP systems in a field, as may be commissioned by a client of a service provider. Such ESPs can be observed as being prone to emulsion formation and issues due to gas degradation. Acquired data can include signals such as pump intake and discharge pressures, temperatures, etc., as well as metadata on well performance, etc. In an example, trial, a dataset for emulsion detection included 134,000 records as training data and 89,440 records as labeled stratified testing data, which provided a label ratio of 45:55, indicating a relatively balanced dataset. As to gas degradation detection, an example trial utilized a dataset with 18,360 records as training data and 12,240 records as testing data, which provided a label ratio of 60:40. In the example trials, the datasets were originally unlabeled/untagged and subjected to quality control and assessment.

As explained, a workflow can include building a framework to assess data quality, evaluating potential for data validation, leveraging assistance from one or more experts to label regions of interest, using one or more machine learning techniques to model consistently identifiable signatures in regions of interest, evaluating accuracy and robustness of such models and building a standalone packaged solution that can be deployed in the field for one or more client wells.

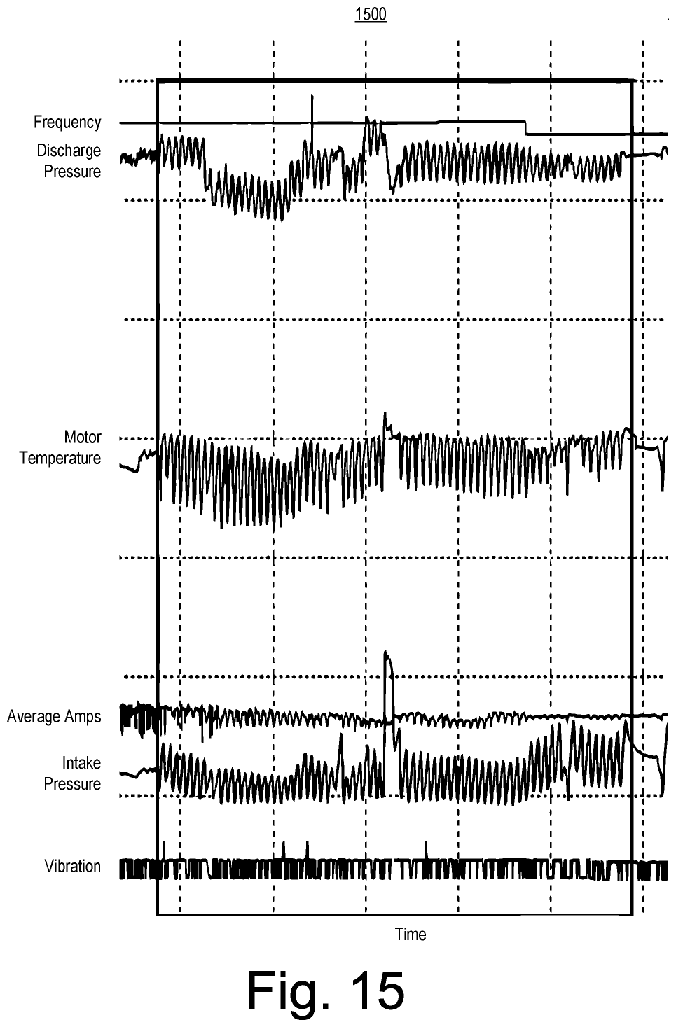

FIG. 15 shows an example plot 1500 that indicates a region of interest for emulsion formation with respect to a series of different types of data including discharge pressure, frequency, motor temperature, intake pressure, average and vibration with respect to time.

In the plot 1500 of FIG. 15, a region of interest analysis may utilize one or more techniques, which may include assessing absolute differences in a region, how much fluctuation exists in a region, whether boundaries are exceeded, etc. In the plot 1500 of FIG. 15, the fluctuations in various data of the time series data tend to be present when emulsions are about to form or are present in an ESP.

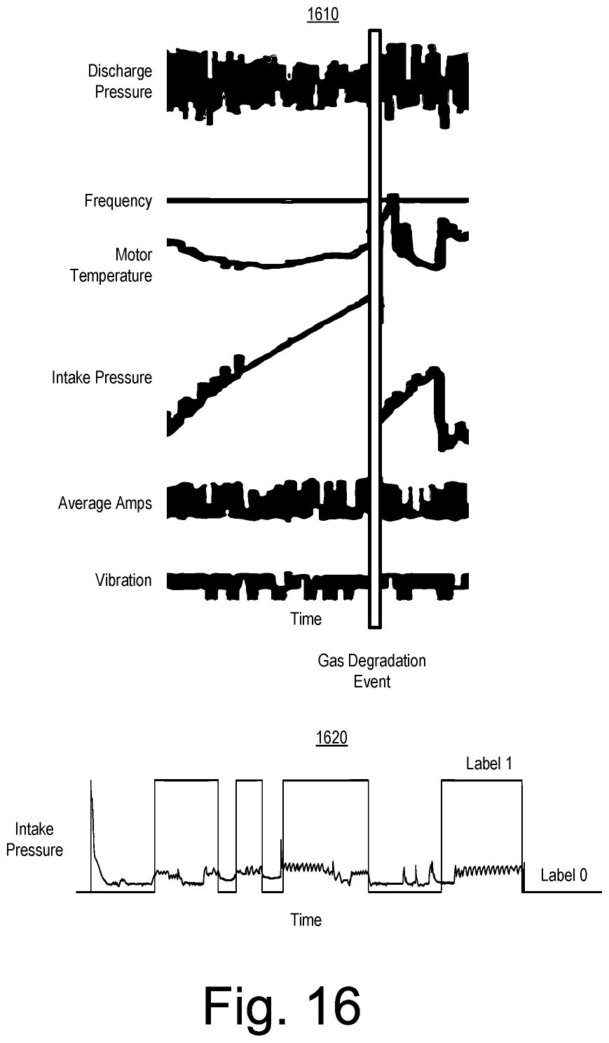

FIG. 16 shows example plots 1610 and 1620 of various types of data along with labeling. For example, the plot 1610 shows a series of different types of data including discharge pressure, frequency, motor temperature, intake pressure, average amperage and vibration with respect to time where a gas degradation event (no/low flow) is labeled, and the plot 1610 shows intake pressure versus time with assigned binary labels of 1 and 0.

In the plot 1610 of FIG. 16, a steep rise and immediate fall in intake pressure (PIP) can provide for indication of a gas degradation event. As an example, a technique may involve assessing slope consistency over time (e.g., one day period) around values for different no flow periods. In gas degradation, two states can exist where one state corresponds to when gas degradation starts to occur where signatures may be somewhat consistent but include some inconsistencies and where another state corresponds to a low to no flow period, which exhibits a relatively consistent signature in various data of time series data.

In the plot 1620 of FIG. 16, as mentioned, intake pressure can be utilized for one or more purposes, which can include emulsion formation detection and/or gas degradation detection. As shown in the plot 1620, fluctuations can occur in intake pressure versus time where such fluctuations are indicative of emulsion formation (e.g., a signature or signatures of emulsions).

As an example, an approach can utilize one or more statistical techniques to assess a portion of time series data. For example, consider a steep rise and an immediate fall, which may be indicative of a gas degradation event. In such an example, the slope of time series data may be assessed, for example, over a period of time. As another example, consider utilization of a boundary for fluctuations to determine a range of fluctuating values as being indicative of presence of an emulsion. Such techniques can be utilized to define various features that can be part of a feature set. In an example trial, over 100 features were defined via a feature engineering stage of a workflow.

As to a modeling workflow, a dataset can be preprocessed to remove certain types of inconsistencies in data, discarding irrelevant signals, imputing missing values and standardizing ranges by detecting and removing outliers.

As indicated in the plot 1620, with respect to one time series of data, each of the separate time series datasets can be labeled with binary indicators (e.g., 0 and 1) to mark the presence of emulsion issues and/or gas degradation issues. Such an approach can provide for supervised learning as labels now exist by which a selected ML model or ML models can learn from.

As an example, a workflow can include selecting multiple preliminary models to be built to assess and rank modeling approaches that do not compromise on explainability or accuracy.

A workflow can include feature engineering and feature selection processes that aim to better incorporate signal behavior, where a model trained on an offline dataset can be evaluated using a holdout section of the original dataset. As explained, holding back data can provide for assessing one or more trained ML models. As an example, a selected assessed ML model or ML models can be containerized for deployment to field-based computing equipment for assessment in the field (e.g., blind testing in the field, etc.). Where one or more ML models are found to perform suitably in the field, the one or more ML models may be brought online for purposes of monitoring and/or control.

As explained, a workflow can include feature engineering, which may be performed on signals in a dataset. As an example, features can be engineered based on rolling window computations, for example, using different window sizes, where functions utilized can range from relatively simple descriptive statistics like the mean and min-max difference to more complex Theil-Sen slopes, median absolute deviation, etc.

In an example trial, 336 features were generated, subsequently reduced using a Lasso regression with 3-fold cross-validation with grid-search performed to select the best value of a regularization parameter. In the trial, this process reduced the feature space to 44 features, features deemed most relevant to the ML model.

As to Lasso regression, it can be implemented as a type of regularized linear regression that includes an L1 penalty that has the effect of shrinking the coefficients for those input variables that do not contribute much to the prediction task. This penalty allows some coefficient values to go to the value of zero, allowing input variables to be effectively removed from the model, providing a type of automatic feature selection.

In the example trial, a random forest model was selected as a final model based on the features using a relatively shallow tree structure with a maximum depth of 6 and using the Gini coefficient criterion to perform splits (e.g., in an entropy approach, etc.). As an example, an approach may utilize a feature reduction technique such as, for example, a dimensionality reduction technique (e.g., principal component analysis (PCA), etc.), for feature reduction to assist with identification of periods of no flow due to gas degradation.

As an example, a decision tree approach may be implemented for emulsion detection and gas degradation detection where, for example, a Lasso approach is utilized for building of decision trees for emulsion detection and a PCA approach is utilized for building of decision trees for gas degradation detection. As PCA reduces data according to principal components, which can lack an explicit physical meaning, a decision tree built using principal components can also be lacking in apparent physical meaning. As such, the presentation of a decision tree in a graphical user interface (GUI), etc., may not necessarily convey meaningful information to a user as to decisions made during traversal of the decision tree to a leaf (e.g., a leaf node, etc.). As an example, an approach may be implemented where physical meaning is retained (e.g., Lasso technique, etc.) and where a GUI or GUIs can be rendered to a display to assist with understanding of one or more conditions by a user and decisions made by a trained ML model. As to utilization of a Lasso approach for gas degradation, it may tend to select particular features and discard others, which can result in suboptimal performance of decision trees. For example, a Lasso approach may tend to favor pressure related features over other such that the other features are excluded and information associated with those other features lost.

As explained, a ML modeling approach can aim to find a sweet spot between overfitting and underfitting. As explained, a decision tree may be utilized where splits (e.g., branching) can be determined along with a decision tree depth. As an example, an approach may include a number of decision trees, which may be organized as individual decision trees where each of the decisions trees provides a result or, for example, as a forest where the forest can provide a result (e.g., via a voting approach, etc.). A decision tree can utilize various features where decisions are made to eventually progress to a leaf of a decision tree, which may be considered an outcome, a result or an output. In an example trial, an approach utilized approximately 100 decision trees where each of the decision trees can provide an output. In the example trial, the decision trees had a number of levels of 6 or less.

Given widespread field site data for pumps such as ESPs, more data tends to exist for emulsions than for gas degradation where datasets for gas degradation can also be less balanced, noting that gas degradation tends to be more detrimental than presence of emulsion. The amount of data can be a factor as to overfitting, which can be addressed via one or more techniques.

FIG. 17 shows an example of a system 1700 that can include a containerized ML model 1710 hosted within an application programming interface (API) wrapper 1720 within a container 1730. In such an example, the containerized ML model 1710 can be deployed in the field, for example, using an edge computing device 1750 with detector 1752 and edge application 1754 components. In such an example, the edge application component 1754 can provide for processing of data such that the data or data derived therefrom are in a form suitable for ingestion by the detector 1752 (e.g., appropriate ML model inputs, etc.).

In the example trials, a data science framework was implemented (DATAIKU) along with a container framework (DOCKER). The container framework provides for construction of a unit of software that packages up executable code and its dependencies such that an application can execute quickly and reliably from one computing environment to another. As an example, a container can be an image that is a lightweight, standalone, executable package of software that includes code, runtime, system tools, system libraries and settings. A container image becomes a “container” at runtime, for example, when run on a suitable engine (e.g., DOCKER engine for a DOCKER container image). As an example, an edge implementation may utilize a framework such as, for example, a lightweight machine learning framework such as the TENSORFLOW LITE (TFL) framework (GOOGLE LLC, Mountain View, California).

As an example, a model inference pipeline can be set up inside a container, wrapped around an ASGI based API technology to allow for real-time requests and responses (see, e.g., arrows in the edge computing device 1750 of FIG. 17). As an example, ESP signals can be received as expected by a ML model in real-time to produce as output a probability of a presence of an issue at that time. Such an approach allows for continuous monitoring and/or control and parallel computation on multiple gateways.

In an example field implementation, a final model for emulsion detection exhibited an accuracy of 87 percent on test data where the AUC of the ROC (Receiver-Operator Characteristic) curve was 0.94. The field implemented system for emulsion detection during ESP operation proved to be a robust solution (accurate over 85 percent on blind testing) for wells from multiple clients of a service provider. The average response time of the system using a gateway implementation was approximately 5 seconds. In an example field implementation, a final model for no flow due to gas degradation exhibited an accuracy of 81 percent where the area under the curve (AUC) of the ROC curve was 0.85 (e.g., a technique to assess performance as to a problem). In various examples, decision thresholds can be adjustable for inclusion of one or more additional unidentified instances of an issue or issues, which may thereby help to reduce false negatives.

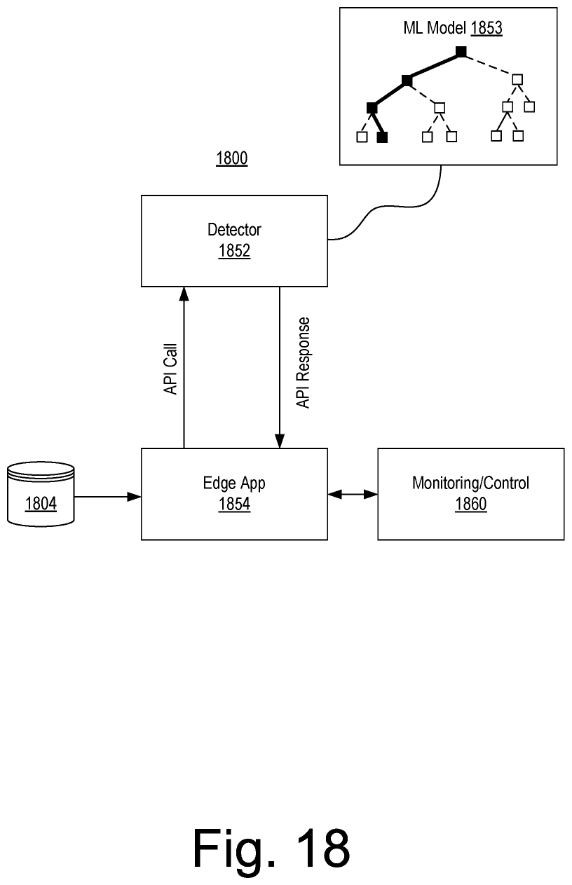

FIG. 18 shows an example of a system 1800 that includes a data source 1804 that can provide, for example, real-time data from one or more sensors deployed in the field as part of or otherwise associated with a pump, an instance of a detector 1852, an instance of an edge application 1854 and an monitoring and/or control component 1860. As shown, the detector 1852 may receive an API call (e.g., an API request) issued by the edge application 1854 and where the detector 1852 acts responsive to the API call to generate an API response directed to the edge application 1854. As shown, the monitoring and/or control component 1860 can be operatively coupled to the edge application 1854 for transmission of data, issuance of an alarm or alarms, issuance of a control command, etc. As explained, the edge application 1854 can provide for data processing, data derivations, etc., which may be suitable for generating appropriate input for the detector 1852.

In the example of FIG. 18, an example of a ML model 1853 is shown, which may be a decision tree that activates a leaf as output where the decision tree can be one of a number of decision trees. As explained, data can be utilized as input and/or can be processed to generate input for a ML model or ML models where the ML model or ML models can provide one or more outputs indicative of whether an issue has arisen or is likely to arise. As an example, a ML model or ML models may output probabilities of a decision, a prediction, etc., which may be tracked for a period of time or over a number of calls, where if output is consistent over such a period of time of the number of calls, an ultimate determination may be made, which may then trigger issuance of an alarm and/or a control instruction.

The example system 1800 of FIG. 18 can be scalable, customizable and standalone and provide reliability and robustness upon initial deployment to an edge computing device or edge computing devices. Such a system may provide real-time results for multiple pumps for multiple wells, reducing downtime for various wells, for example, by over 25 percent.

As explained, one or more features of a system may be associated with equipment that can be deployed downhole. For example, the circuitry 460 of FIG. 4 can include one or more features of the edge device 510 of FIG. 5, which can, for example, provide for hosting the detector 1852 and the edge application 1854 of FIG. 8; noting that multiple detectors and/or applications may be hosted (e.g., wholly and/or in part). As an example, an ESP may itself be a “smart” ESP that includes one or more executable models (e.g., ML models, etc.) that can provide for monitoring and/or control of the ESP. As explained, circuitry may be carried by a gauge that can be mounted to an assembly that includes a pump and a motor where one or more sensors of the gauge can provide inputs to monitoring and/or control circuitry.

As an example, an emulsion detector deployed to the edge can help to reduce repair and replacement costs considerably. As an example, an inference pipeline can be generalized, repeatable and expandable. As an example, a workflow can provide for building ML models, deploying ML models and implemented ML models in a manner that increases productivity of experts, for example, by reducing issue detection time from hours to a few minutes per event.

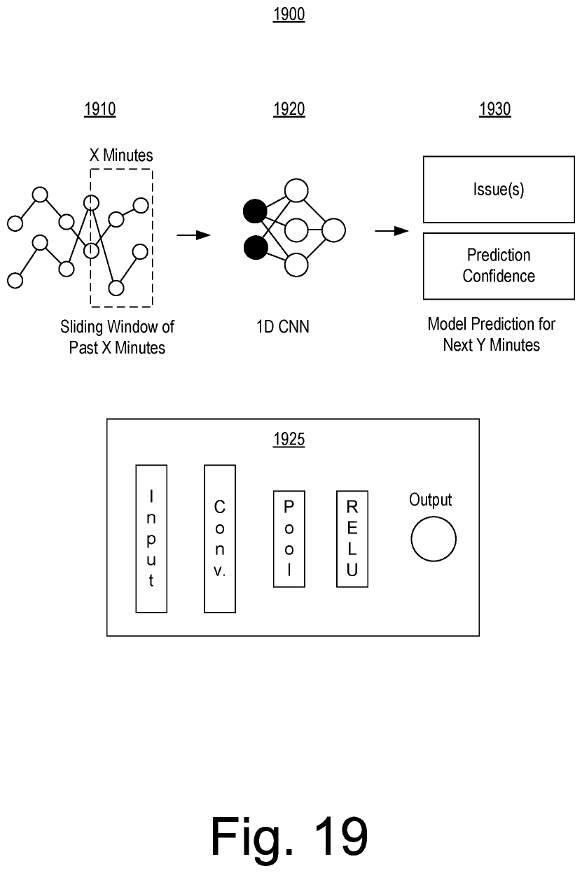

FIG. 19 shows an example of a method 1900 that includes a sliding window block 1910, a 1D convolution neural network block 1920 and a model prediction block 1930. As shown, a sliding window can be implemented per the sliding window block 1910 for time series data where a window span may be selected. In the example of FIG. 19, the window span is selected to be a number of hours, noting that a lesser or greater time span may be selected. As an example, a window span may be selected on the basis of physical phenomena that occur prior to or during an event. For example, as to a gas degradation event, it may exhibit behavior in one or more time series signals over a span of hours such that a window span can be selected to capture such behavior in the one or more of the time series signals.

As to the 1D convolution neural network (CNN) block 1920, it can include an architecture, such as an example architecture 1925, with various layers. For example, consider a 1D CNN that includes an input layer that takes a fixed length of a time series and passes the input to a convolutional layer. In such an example, the convolutional layer and a pooling layer can smooth the input. As shown, an RELU layer can apply an RELU non-linear transformation to the smoothed input. In the example architecture 1925, the output layer can take a vector-valued result of the RELU layer. In such an example, the output layer may utilize one or more activation functions to provide one or more types of output (e.g., class probabilities, a continuous-valued response, counts, or some other type of response based on the choice of activation function).

As to convolution, it can help to diminish noise (e.g., via smoothing), for example, such that a resulting plot of time series data is less jagged. As explained, output of a convolution layer can be pooled, using a pooling layer. For example, consider applying average pooling with pools of a selected size (or sizes). The output of a pooling layer can be a smoother representation of the output of a convolution layer such that, for example, if signal, as in signal versus noise, exists in the input time series data, the signal may be easier to identify in an average pooling plot.

As explained, a 1D CNN can include convolutional and max pooling layers that apply smoothing to an input vector, which can be a fixed length sub-sequence of a time series (e.g., according to a window span, etc.). As an example, such a 1D CNN can be trained to learn smoothing parameters jointly with classification or regression parameters.

In the example of FIG. 19, the method 1900 can include the model prediction block 1930 where a prediction can be output, for example, as to an event or no event within a period of time that extends into the future, which may be output with a prediction confidence. For example, consider a prediction of a gas degradation event, an emulsion event, etc., or a prediction of no gas degradation event, no emulsion event, etc., within 30 minutes where the prediction can have an associated confidence (e.g., within a range that may be greater than a threshold value, etc.). While gas degradation and emulsion events are mentioned, one or more other events may be predicted using an approach as in FIG. 19 (e.g., gas lock, motor winding temperature, wear, operational condition, efficiency, etc.).

As an example, a framework can include utilization of one or more ML models. For example, consider one or more types of 1D CNN ML models. As an example, ML models may be chained. For example, consider utilization of one or more ML models for each channel of time series data, which may, for example, smooth such time series data prior and make such smoothed time series data available to another ML model for purposes of training, prediction, etc.

As an example, a system, a method, etc., may utilize one or more machine learning features, which can be implemented using one or more machine learning models. As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange for various other frameworks.

As an example, a system may utilize one or more recurrent neural networks (RNNs). One type of RNN is referred to as long short-term memory (LSTM), which can be a unit or component (e.g., of one or more units) that can be in a layer or layers. A LSTM component can be a type of artificial neural network (ANN) designed to recognize patterns in sequences of data, such as time series data. When provided with time series data, LSTMs take time and sequence into account such that an LSTM can include a temporal dimension. For example, consider utilization of one or more RNNs for processing temporal data from one or more sources, optionally in combination with spatial data. Such an approach may recognize temporal patterns, which may be utilized for making predictions (e.g., as to a pattern or patterns for future times, etc.).

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs, noting that the name TENSORFLOW derives from the operations that such neural networks perform on multidimensional data arrays. Such arrays can be referred to as “tensors”.

As an example, a device and/or distributed devices may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). Multiple platform support, covering ANDROID and iOS devices, embedded LINUX, and microcontrollers. Diverse language support, which includes JAVA, SWIFT, Objective-C, C++, and PYTHON. High performance, with hardware acceleration and model optimization. Machine learning tasks may include, for example, data processing, image classification, object detection, pose estimation, question answering, text classification, etc., on multiple platforms. As an example, the system 500 of FIG. 5 may utilize one or more features of the TFL framework.

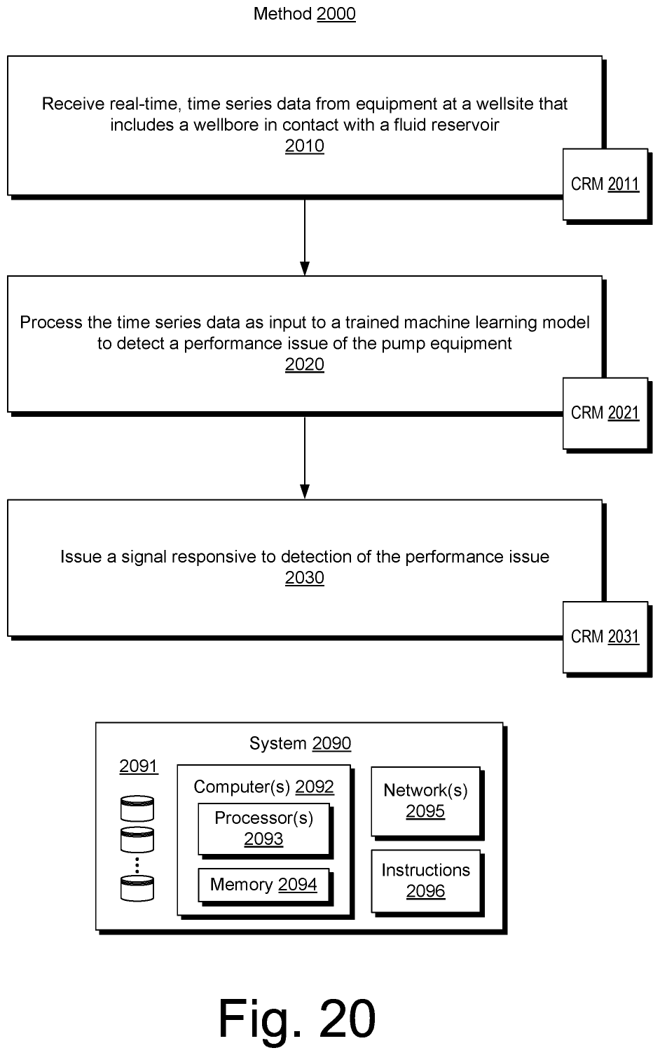

FIG. 20 shows an example of a method 2000 and an example of a system 2090. As shown, the method 2000 can include a reception block 2010 for receiving by a computational device at a wellsite, real-time, time series data from pump equipment at the wellsite, where the wellsite includes a wellbore in contact with a fluid reservoir; a process block 2020 for, using the computational device, processing the time series data as input to a trained machine learning model to detect a performance issue of the pump equipment; and an issuance block 2030 for issuing a signal responsive to detection of the performance issue.

The method 2000 is shown in FIG. 20 in association with various computer-readable media (CRM) blocks 2011, 2021 and 2031. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 2000. As an example, a computer-readable medium (CRM) may be a computer-readable storage medium that is non-transitory and that is not a carrier wave. As an example, one or more of the blocks 2011, 2021 and 2031 may be in the form of processor-executable instructions.

In the example of FIG. 20, the system 2090, which may be a wellsite system, can include one or more information storage devices 2091, one or more computers 2092, one or more networks 2095 and instructions 2096. As to the one or more computers 2092, each computer may include one or more processors (e.g., or processing cores) 2093 and memory 2094 for storing the instructions 2096, for example, executable by at least one of the one or more processors 2093 (see, e.g., the blocks 2011, 2021 and 2031). As an example, a computer may include one or more network interfaces (e.g., wired or wireless), one or more graphics cards, a display interface (e.g., wired or wireless), etc.

As explained, a comprehensive smart alarm suite for pumps can be provided by a system for detection of various behaviors, conditions, etc., during pump operations. Such a system may provide for issuance of one or more control actions to reduce risk of unwanted events, which may lead to deferred oil reduction. As explained, edge computational devices can be utilized for implementation of data-driven and/or rule-based logic and, for example, to provide one or more edge based simulators such as a VFM to provide information regarding the real-time flowing conditions. Being able to evaluate the health conditions of a pump in real-time can provide end-users with an ability to enhance control of a field under operation and conserve precious time to perform various actions, which may help to reduce risks. During a building phase of a model or models, a method can include testing using real field events for validation and accuracy control. As explained, one or more transitions may be performed, for example, from one type of a model to another, which can include one or more hybrid approaches. As an example, a system can provide for labeling, optionally in an automated manner, which can facilitate training of one or more ML models, which may be trained in a supervised and/or unsupervised manner.

As an example, a method can include receiving by a computational device at a wellsite, real-time, time series data from pump equipment at the wellsite, where the wellsite includes a wellbore in contact with a fluid reservoir; using the computational device, processing the time series data as input to a trained machine learning model to detect a performance issue of the pump equipment; and issuing a signal responsive to detection of the performance issue. In such an example, the performance issue may be an emulsion issue, where an emulsion reduces performance of the pump equipment, the performance issue may be a gas issue, where gas reduces performance of the pump equipment, the performance issue may be a wear issue, where wear reduces performance of the pump equipment, or the performance issue may be another type of issue that reduces performance of the pump equipment. As to gas issues, consider, for example, gas degradation and gas lock, either of which can reduce performance of pump equipment. As an example, a method can include selecting one or more performance issue components from a suite of performance issue components, which may be selected automatically, semi-automatically and/or manually, for example, depending on particulars of a wellsite, a wellbore, a fluid reservoir, fluid and/or pump equipment.

As an example, a trained machine learning model can include at least one decision tree. As an example, a trained machine learning model can include more than ten decision trees.

As an example, a computational device at a wellsite can include a processor, memory and processor-executable instructions stored in the memory to instantiate an application and a detector, where the detector includes an instance of a trained machine learning model. In such an example, the application processes time series data to generate input and can issue an application programming interface (API) call to the detector, where the detector issues an application programming interface (API) response to the application. As an example, instructions may be containerized and suitable for use with one or more frameworks, which can include a machine learning framework. As explained, a computational device may be a surface device and/or a downhole device.

As an example, a computational device at a wellsite can include a virtual flow meter component that includes an instance of a flow simulator. In such an example, the flow simulator may be a lightweight version of a flow simulator that is operable using cloud-based computational resources and/or high performance workstation resources as may be implemented in parallel (e.g., parallel processing using multiple processors, CPUs, GPUs, etc.).

As an example, a computational device at a wellsite can include issue detectors and at least one trained machine learning model that corresponds to at least one of the issue detectors. In such an example, the issue detectors can include virtual flow meter dependent issue detectors. For example, virtual flow meter dependent issue detectors can include one or more of an operational condition issue detector, a wear issue detector, a performance index drop issue detector and a tubing leak alarm issue detector; noting that each of such issue detectors can be utilized to detect one or more performance issues. As an example, one or more issue detectors may or may not depend on utilization of a virtual flow meter. For example, consider one or more of a gas degradation issue detector, an emulsion issue detector, and a motor winding temperature issue detector for a motor of pump equipment that may not depend on utilization of a virtual flow meter. As explained, issue detectors can include at least one trained machine learning model based issue detectors.

As an example, a trained machine learning model can include decision trees, where each of the decision trees includes less than 10 layers or less than 8 layers. For example, consider decision trees that include 6 layers or less. As an example, a decision tree can include at least two layers.

As an example, a trained machine learning model can include decision trees, where the decisions trees are built using Lasso regression. As an example, a trained machine learning model can include decision trees, where the decisions trees are built using principal component analysis.

As an example, a method can include building a trained machine learning model using a dataset that is split into training data and testing data, where the testing data may include holdout data.

As an example, a method can utilize a trained machine learning model that can be a first model where a performance issue is a first performance issue and such a method can include utilizing another trained machine learning model as a second model for detection of a second performance issue. In such an example, the first performance issue can be a gas issue and where the second performance issue can be an emulsion issue. For example, consider a gas degradation issue or a gas lock issue or a scenario where three trained machine learning models are utilized for detection of gas degradation, gas lock and emulsion issues.

As an example, a method can include utilizing pump equipment where the pump equipment includes an electric submersible pump that includes one or more sensors that generate at least a portion of real-time, time series data that can be processed for input to at least one trained machine learning model. In such an example, the pump equipment may host a trained machine learning model, which may be hosted by surface circuitry (e.g., a surface controller, a surface edge framework gateway, etc.) and/or downhole circuitry. As an example, an edge device can be a surface edge device and/or a downhole edge device. As explained, an edge device can host one or more detectors and one or more applications where an application may process real-time, time series data to generate input suitable for a trained machine learning model and/or another model for performing issue detection, etc.

As an example, a wellsite system can include a processor; memory accessible to the processor; and processor-executable instructions stored in the memory to instruct the system to: receive real-time, time series data from pump equipment at the wellsite, where the wellsite includes a wellbore in contact with a fluid reservoir; process the time series data as input to a trained machine learning model to detect a performance issue of the pump equipment; and issue a signal responsive to detection of the performance issue. In such an example, the signal can be an alarm signal and/or a control signal. For example, a monitoring process may monitor alarm signals, which may be assessed by human and/or machine for purposes of issuing a control signal. Or, for example, a control signal may be issued automatically in response to detection of a condition, conditions, a behavior, behaviors, etc. As an example, a signal may be a hybrid signal that is both an alarm signal and a control signal. For example, consider a hybrid signal that alerts as to a gas issue and controls a pump to address the gas issue or a hybrid signal that alerts as to an emulsion issue and controls a pump to address the emulsion issue. Other hybrid examples can pertain to motor winding temperature, wear, efficiency, etc.

As an example, one or more computer-readable storage media can include processor-executable instructions to instruct a wellsite computing system to: receive real-time, time series data from pump equipment at the wellsite, where the wellsite includes a wellbore in contact with a fluid reservoir; process the time series data as input to a trained machine learning model to detect a performance issue of the pump equipment; and issue a signal responsive to detection of the performance issue.

As an example, a computer program product can include one or more computer-readable storage media that can include processor-executable instructions to instruct a computing system to perform one or more methods and/or one or more portions of a method. Various example methods may be performed in various combinations.

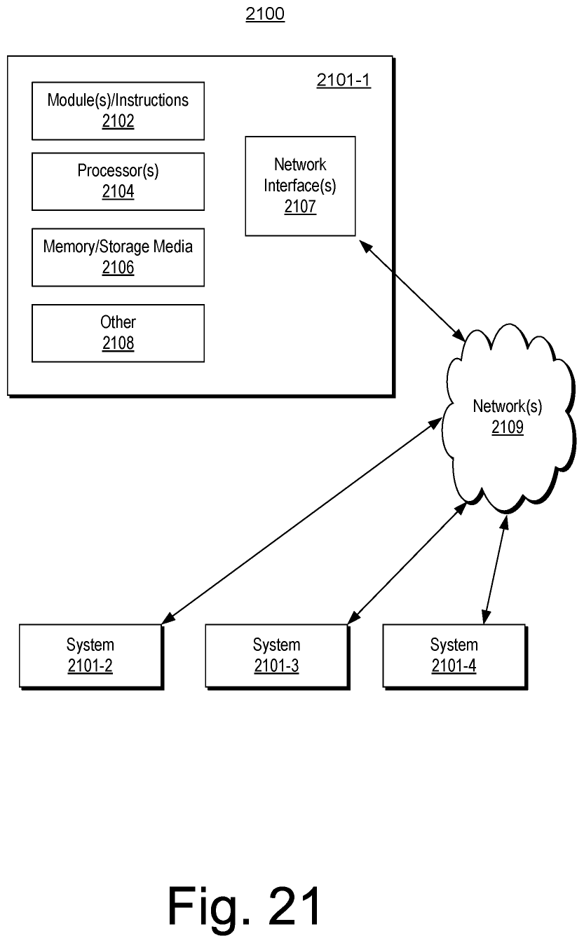

In some embodiments, a method or methods may be executed by a computing system. FIG. 21 shows an example of a system 2100 that can include one or more computing systems 2101-1, 2101-2, 2101-3 and 2101-4, which may be operatively coupled via one or more networks 2109, which may include wired and/or wireless networks.

As an example, a system can include an individual computer system or an arrangement of distributed computer systems. In the example of FIG. 21, the computer system 2101-1 can include one or more modules 2102, which may be or include processor-executable instructions, for example, executable to perform various tasks (e.g., receiving information, requesting information, processing information, simulation, outputting information, etc.).

As an example, a module may be executed independently, or in coordination with, one or more processors 2104, which is (or are) operatively coupled to one or more storage media 2106 (e.g., via wire, wirelessly, etc.). As an example, one or more of the one or more processors 2104 can be operatively coupled to at least one of one or more network interface 2107. In such an example, the computer system 2101-1 can transmit and/or receive information, for example, via the one or more networks 2109 (e.g., consider one or more of the Internet, a private network, a cellular network, a satellite network, etc.).

As an example, the computer system 2101-1 may receive from and/or transmit information to one or more other devices, which may be or include, for example, one or more of the computer systems 2101-2, etc. A device may be located in a physical location that differs from that of the computer system 2101-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 2106 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

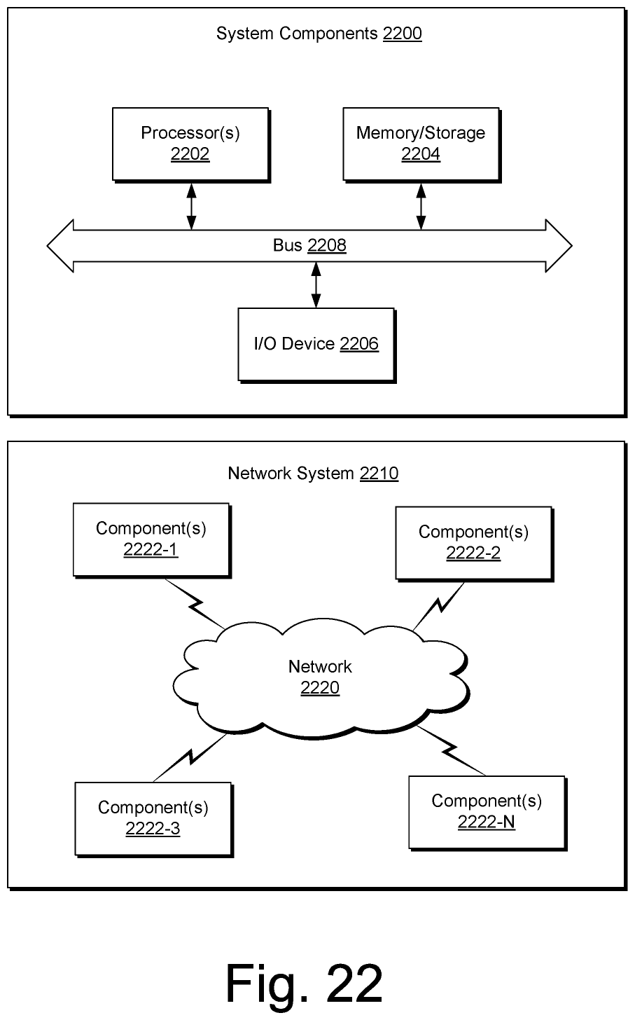

FIG. 22 shows components of an example of a computing system 2200 and an example of a networked system 2210 with a network 2220. The system 2200 includes one or more processors 2202, memory and/or storage components 2204, one or more input and/or output devices 2206 and a bus 2208. In an example embodiment, instructions may be stored in one or more computer-readable media (e.g., memory/storage components 2204). Such instructions may be read by one or more processors (e.g., the processor(s) 2202) via a communication bus (e.g., the bus 2208), which may be wired or wireless. The one or more processors may execute such instructions to implement (wholly or in part) one or more attributes (e.g., as part of a method). A user may view output from and interact with a process via an I/O device (e.g., the device 2206). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 2210. The network system 2210 includes components 2222-1, 2222-2, 2222-3, . . . 2222-N. For example, the components 2222-1 may include the processor(s) 2202 while the component(s) 2222-3 may include memory accessible by the processor(s) 2202. Further, the component(s) 2222-2 may include an I/O device for display and optionally interaction with a method. The network 2220 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving by a computational device at a wellsite, real-time, time series data from pump equipment at the wellsite, wherein the wellsite comprises a wellbore in contact with a fluid reservoir;
using the computational device, processing the time series data as input to a trained machine learning model to detect a performance issue of the pump equipment; and
issuing a signal responsive to detection of the performance issue.

2. The method of claim 1, wherein the performance issue is an emulsion issue, wherein the emulsion reduces performance of the pump equipment.

3. The method of claim 1, wherein the performance issue is a gas degradation issue, wherein the gas degrades performance of the pump equipment.

4. The method of claim 1, wherein the trained machine learning model comprises at least one decision tree.

5. The method of claim 1, wherein the computational device at the wellsite comprises a processor, memory and processor-executable instructions stored in the memory to instantiate an application and a detector, wherein the detector comprises an instance of the trained machine learning model.

6. The method of claim 5, wherein the application processes the time series data to generate the input and issues an application programming interface call to the detector, and wherein the detector issues an application programming interface response to the application.

7. The method of claim 1, wherein the computational device at the wellsite comprises a virtual flow meter component that comprises an instance of a flow simulator.

8. The method of claim 1, wherein the computational device at the wellsite comprises issue detectors and wherein the trained machine learning model corresponds to one of the issue detectors.

9. The method of claim 8, wherein the issue detectors comprise virtual flow meter dependent issue detectors.

10. The method of claim 9, wherein the virtual flow meter dependent issue detectors comprise one or more of an operational condition issue detector, a wear issue detector, a performance index drop issue detector and a tubing leak alarm issue detector.

11. The method of claim 8, wherein the issue detectors comprise one or more of a gas degradation issue detector, an emulsion issue detector, and a motor winding temperature issue detector for a motor of the pump equipment.

12. The method of claim 8, wherein the issue detectors comprise more than one trained machine learning model based issue detector.

13. The method of claim 1, wherein the trained machine learning model comprises decision trees, wherein each of the decision trees comprises less than 10 layers.

14. The method of claim 1, wherein the trained machine learning model comprises decision trees, wherein the decisions trees are built using Lasso regression.

15. The method of claim 1, wherein the trained machine learning model comprises decision trees, wherein the decisions trees are built using principal component analysis.

16. The method of claim 1, comprising building the trained machine learning model using a dataset that is split into training data and testing data, wherein the testing data comprises holdout data.

17. The method of claim 1, wherein the trained machine learning model is a first model and wherein the performance issue is a first performance issue and further comprising another trained machine learning model as a second model for detection of a second performance issue.

18. The method of claim 1, wherein the pump equipment comprises an electric submersible pump that comprises one or more sensors that generate at least a portion of the real-time, time series data.

19. A wellsite system comprising:
a processor;
memory accessible to the processor; and
processor-executable instructions stored in the memory to instruct the system to:
receive real-time, time series data from pump equipment at the wellsite, wherein the wellsite comprises a wellbore in contact with a fluid reservoir;
process the time series data as input to a trained machine learning model to detect a performance issue of the pump equipment; and
issue a signal responsive to detection of the performance issue.

20. One or more computer-readable storage media comprising processor-executable instructions to instruct a wellsite computing system to:
receive real-time, time series data from pump equipment at the wellsite, wherein the wellsite comprises a wellbore in contact with a fluid reservoir;
process the time series data as input to a trained machine learning model to detect a performance issue of the pump equipment; and
issue a signal responsive to detection of the performance issue.
